(19) United States
(12) Patent Application Publication
(10) Pub. No.: US 2005/0193198 A1
(43) Pub. Date: Sep. 1, 2005

(54) System, method and apparatus for electronic authentication

(76) Inventor: Jean-Michel Livowsky, Lury (CH)

Correspondence Address: HOWREY LLP, C/O IP DOCKETING DEPARTMENT, 2941 FAIRVIEW PARK DR, SUITE 200, FALLS CHURCH, VA, 22042-2924, US

(21) Appl. No.: 11/050,827

(22) Filed: Jan. 27, 2005

Related U.S. Application Data
(60) Provisional application No. 60/539,104, filed on Jan. 27, 2004.
(60) Provisional application No. 60/541,234, filed on Feb. 4, 2004.

(51) Int. Cl. H04L 9/00

(52) U.S. Cl. 713/168

(57) ABSTRACT

A system, method and apparatus for on-line authentication of a user. The system may include an authentication device, such as a portable authentication token, in communication with an authentication server or system of a trusted party. In one aspect, authentication is based on an authentication curve or data derived from it, the authentication curve being mapped from points that are based on a combination of unique data stored or obtained by the authentication device and provided to the authentication server, and on information stored or obtained at the authentication server. In one embodiment, authentication is based at least in part on biometric data of a user to be authenticated.

### PRIORITY

This application claims priority to U.S. Provisional Patent Application No. 60/539,104, filed Jan. 27, 2004 and entitled “System, Method and Apparatus For Redundancy and Anonymity in Electronic Authentication”, and U.S. Provisional Patent Application No. 60/541,234, filed Feb. 4, 2004 and entitled “System, Method and Apparatus For Improved Electronic Authentication”. Each of these applications is hereby incorporated herein by reference in its entirety.

### BACKGROUND OF THE INVENTION

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

1. Field of the Invention

The present invention relates generally to electronic user authentication. More specifically, the present invention relates to a system and method for authenticating a user from a remote location in a flexible manner while offering a high degree of security. In one aspect, the invention may offer an authentication method that utilizes a redundancy concept to enable recovery of lost authentication information and/or maintenance of an overall authentication attribute. In another aspect, the invention may provide for generation of such an authentication attribute in such a manner that the information needed to generate that attribute are not permanently stored. In yet another aspect, the invention may offer anonymous authentication. In yet another aspect, the invention may allow for the protection and/or recovery of information stored on a detachable/portable or other authentication device.

2. Related Art

Methods and systems for electronically authenticating a remote user are well known in the art. In particular, authenticating a user on a computer via a network been increasingly used in recent decades, particularly since the Internet has become available worldwide.

However, an increasing number of confidential operations such as banking operations are achieved through use of worldwide public computer networks such as the Internet. It is therefore important that only a reliably authenticated user is allowed access to these types of operations. This is especially true for banking operations and more broadly, for any operations that may involve confidential or otherwise sensitive information for either the sender and/or the recipient of network transmitted information, and/or for a third party.

State of the art methods and systems allow for a reasonable amount of security. However, most of these methods work by applying an encrypting function to a user-supplied authentication key. The encrypting function is chosen to be a complex function, the details of which are difficult to determine. Typically, a user is authenticated when the user's encrypted key matches a reference value computed upon the user's initial access to the associated authentication system. However, increased computer processor speed and improvements in such areas as code breaking and hacking have made it easier for unauthorized users to break the codes associated with these protective measures. That is, to obtain the original user's key solely on the basis of an encrypted value, thus reducing the security obtained by these networks.

This issue is especially critical in the area of electronic payment means such as credit or payment cards, where worldwide fraud amounts to hundreds of billions dollars yearly.

The most common means of credit or payment worldwide use simple magnetic track cards. Since these “dumb” cards cannot “ask” for a password to perform requested operations, counterfeiting a card may involve merely duplicating visual appearance and information stored on magnetic tracks.

To circumvent this possibility, “smart” cards have been introduced that embed a microprocessor chip to allow checking of a user-provided password or other security information. However, there are now emerging possibilities to forge counterfeit smart cards, allowing unauthorized performance of illegal transactions on related banking accounts, with associated financial consequences for victim merchants, customers and/or banks. Moreover, mere existence of these fake credit or payment smart cards opens many opportunities for an unscrupulous customer, such as to repudiate a genuine transaction.

Additionally, current credit or payment card authentication systems impose somewhat complicated procedures in the case of a lost or stolen smart card, or in the event of a forgotten associated password. Usually, the procedure involves sending back a new smart card to the client, along with selecting a new password. Practically, this procedure can be complicated when the card is stolen or lost, particularly if this occurs while the user is away from home, such as in another country. The customer may be isolated overseas without payment means for a period of time that can amount to weeks.

Furthermore, present systems based solely on a user-typed password allow a perfectly honest customer to have his smart card stolen after his password has been observed by a thief, for example at an automated cash dispenser. More recently, impostor smart cards have been fabricated with corresponding passwords, allowing for illegal debit operations from an innocent third party banking account. Again, the mere existence of these fake smart cards allows an unfair customer to repudiate a genuine transaction of his own. These drawbacks of present systems and methods translate into reduced security and reliability in a number of areas. In addition to creating risks for financial or other sensitive transactions, locations relying on secured access methods including smart ID cards and others may be compromised.

Therefore, there is a need for a method and a system that allow authentication of an entity in a highly reliable and secure way. The authentication may be network-based, and may offer convenient recovery of lost data without requiring initial steps of an authentication process (e.g., registration-type steps) to be repeated. This may include full recovery in the event of lost or stolen authentication device, including recovery of data stored and managed therein.

### SUMMARY OF THE INVENTION

Accordingly, the present invention, in one embodiment, provides a user authentication method that includes using an authentication device to communicate with an authentication system over a network. The authentication device may include at least a memory means, a main processor means to process information contained in the memory means and a communication interface to send and receive information to and from the authentication system over the network. The authentication system may also include at least a memory means, a processor means to process information contained in the memory means and a communication interface to send and receive information to and from the authentication device over the network. Data transmitted by the authentication device may be combined with data provided by the authentication system to map at least two points, a curve, which may be a polynomial curve, being calculated that includes these at least two points. In one aspect, a user may be positively authenticated only if predefined values derived from the polynomial curve, such as one or more points of the curve, match or belong to the generated curve. The associated values may be stored in the memory means of the authentication system.

The present invention also provides a method wherein the authentication device further includes an input device allowing a user to enter data in the authentication device, where the data transmitted to the authentication system may include this information. In one embodiment, the user-entered data includes biometric data. The authentication unit may also include a secondary processor means, where the secondary processor may be used to control access to a secondary memory means and/or the biometric sensor means. Biometric measures may include a fingerprint sampling, an iris scan, a retinal scan, a voice scan or others known in the art (or any future biometric sensor means, such as a DNA micro-scanner, etc.). The biometric sensor means may be located in stand alone device, or removably or permanently integrated in the authentication device, such as an USB connected device or a device of smart card type.

In one embodiment, an authentication curve, or other chosen authentication data based on the curve, is defined upon initial registration of a user into the authentication system. For example, data from the authentication device may be used to generate at least one abscissa value used in mapping at least one of the at least two mapped points, and data provided by the authentication system may be used to generate at least one ordinate value used in mapping at least one of the at least two mapped points.

Of course, it is also contemplated that an authentication curve may be based on more than two points. In such an embodiment, additional forms of authentication information could be required, and a resulting polynomial curve could be more complex (of a higher degree). Additionally, still further, redundant points may be stored. In the event of the loss of the origin of information used in generating a point, the redundant points could be used to recover the lost information.

For example, in one embodiment, the curves used are based on second-degree polynomials and are thus parabolic. Like all coefficients discussed herein, polynomial coefficients can belong to any field, e.g., the fields of Real or Rational values, or, as another example, a finite field, such as a field of integers modulo a prime number.

In the invention, the data transmitted by an authentication device may include data inherent or permanently stored in the device itself. For example, a unique identifier may be stored in one or more components of the authentication device during fabrication. As with all data stored and/or transmitted during the course of practice of the present invention, this information may be stored in an encrypted, obfuscated or otherwise coded form. Encryption or obfuscation techniques may include SHA-1, RSA, MD-5, an elliptic curve based algorithm, etc., or other technologies known in the art, as discussed in greater detail below.

In one embodiment the authentication system includes an input device that allows data entry by an operator. For example, one or more items of authentication data used might be provided to an operator (e.g., during a telephone call for assistance), who then enters the data into the system.

The method and system of the invention are such that they may be utilized to fulfill the needs of individuals who require some level of authentication stronger than is offered by existing authentication means. The method and system described herein may offer an improved level of confidence, convenience and/or cost efficiencies, among other benefits, as compared to certain known authentication methods, such as those based on single-factor (a.k.a. “weak”) authentication means; two-factor authentication means which combine, for example, the use of something known, such as a PIN or a Password, and something possessed, such as a hardware device protected by a PIN, a Password or equivalent factor.

In one aspect, an authentication method and system of the present invention might allow users to authenticate themselves using identification and/or authentication codes that are neither stored nor written nor managed inside users' devices or networks. This feature might offer assurance against code-breaking and may allow users to be terminal-independent when providing authentication information, such as to a system over a network. In one embodiment, users might be allowed to change an authentication device, for upgrade, lost or theft reasons, with the assurance that their replaced devices do not contain any data that could be used to compromise future authentication by malicious individuals. Likewise, users might be assured that authentication devices could be lost or stolen without fears of ID theft and/or impersonation, that only authorized and legitimate users can recover the data these authentication devices store and manage.

With respect to authentication, the invention may offer various “assurance levels” with respect to reliability, protection of identity and digital ID theft and/or impersonation, authentication factors used, etc. In one embodiment, a method and system of the invention are designed to be technology- and/or terminal-independent, potentially allowing a user's communications infrastructure to comply with several market as well as legal standard-based security criteria.

The importance of managing user anonymous credentials and protecting user privacy has been assessed by a number of organizations, including the U.S. General Services Administration. For example, the following has been noted: “Anonymous credentials may be appropriate when it is not necessary that authentication be associated with a known personal identity (as opposed to identity authentication). To protect privacy, it is important to balance the need to know who is communicating with Government with a citizen's right to privacy. This includes ensuring that information is used only in the manner in which individuals have been assured it will be used. In some cases, it may be desirable to preserve the anonymity of individuals and it may be sufficient for the purposes of an application to authenticate that—(i) The user is a member of a group; and/or (ii) The user is the same individual who supplied or created information in the first place; and/or (iii) A particular user is entitled to use a particular pseudonym. These anonymous credentials will have limited application. In some cases, individuals would have an anonymous as well as a non-anonymous credential. Anonymous credentials can be used up until level 3.” U.S. GSA [2003-N02] E-Authentication Policy for Federal Agencies; Request for Comments, Vol. 68, No. 133, Friday, Jul. 11, 2003 Notices (heading “Use of Anonymous Credentials” incorporated herein by reference).

Thus, the method and system of the invention may offer such anonymous user authentication and provide users with assurance levels against potential infringement of their privacy rights. For example, in certain implementations a user might remain anonymous, such as when being authenticated by a service provider who only needs to know that an authenticated individual has legitimate rights to access physical and logical resource. This may be the case even absent a providers ability to directly authenticate a user's identity.

With respect to recovery of authentication ability in the event of a lost or stolen authentication device or data, as noted above, certain efficiencies might be achieved. By offering a user the capability to self-manage the issuance, usage and/or post issuance of the identification factors in accordance with method and system, certain “identity management” cost reductions might be achievable. For example, in embodiment, users who would like to create, add, delete or revoke one or more of their identification factors may do so at any time in a secure and friendly manner without having to rely on costly call centers, security administrators, etc. Such a feature might also enhance a user's ability to adapt his or her authentication requirements to various communication environments, and vice-versa. The ability to combine the enrollment of an authentication device together with the recovery of data that is stored and managed in a device that may be lost or stolen may also lead to certain efficiencies. For example, users who may lose their devices or have them stolen can be offered the capability to recover the data that was stored and managed in these devices, as well as any or all ID credentials supported by legacy SKI and PKI methods and systems. This might avoid an often-costly step of key revocation/renewal.

In another aspect, a method and system of the invention may enable a user to be authenticated using identification factors that may vary in number and nature and therefore evolve in a flexible manner. Such identification factors might include, but are not limited to, a data item known by a user, such as a number, a password, a PIN code, etc.; something a user has, such as a terminal or a device with its associated unique serial number or other identifier; and something a user “is,” such as a biometric trait. By combining several of identification factors of this or another nature, method and system of the invention be interoperable with, support and/or leverage the nature and number of identification factors and form factors used, such as in legacy and next generation user authentication infrastructures alike.

Anticipating that users may, in the future, be authenticated through the use of a growing number of identification factors and form factors, it is contemplated that a user of the present invention may offers a capability to “federate” multiple user identification factors and provide individuals with a single, united or unified authentication system, that is, to allows users to use the same user name, password or other personal identification to access computers or networks, etc., of more than one network or system, in order to access data, conduct transactions, etc. Similarly, as it becomes more common to use biometric factors to identify and authenticate individuals for physical and logical access to physical and logical systems, it is contemplated that a method and system might be also used to combine items of authentication data, such as biometric-based data together with other data for authentication.

Federated management of multiple identification factors in accordance with a method and system of the invention may enable use of scalable authentication services at both ID-user and ID-provider levels. By allowing a user to enroll multiple and up to a limitless number of identification factors, whether they are knowledge-, device- or biometric- or otherwise-based, this feature of multiple identification factors might allow ID providers to scale the number and/or nature of applications and services for which each enrolled use is authorized to have access. Accordingly, the invention may provide scalable user authentication services for an unlimited number and unqualified nature of individuals, device and data.

In accordance with one aspect of the invention, a user may be allowed to smoothly upgrade a level of confidence, convenience, cost efficiency, etc, of applicable authentication services. For example, the implementation of the invention for use with a single-factor, static-password-based authentication system may enable an immediate migration to a multiple-factor authentication system. While seeking to provide increased confidence in network-based services and applications and lowered operating cost associated with password management operations, such a migration may leave a legacy “User Name+Password” user experience unaffected. A method and system of the invention may thereby enable user and data authentication services to become pervasive features of a next generation of communication systems.

A method and system of the invention may be applied to a large number and a widely varying nature of applications and services in today's and tomorrow's society and economy. Examples of such applications include, but are not limited to, financial institutions that may want to provide advanced “multi-channel” banking systems, government agencies that may want to improve their electronic-authentication capabilities for physical and logical access control, telecommunications operators that may want to offer new “Managed Identity” features embedded in voice-, video- and/or data-based Internet-Protocol (IP) services. Public and private corporations that play a role in the organization of digital societies and economies may also benefit from the implementation of a new method and system in accordance with the invention. Contemplated is the capability to enable individuals—in their citizen, employee, partner, customer and other roles—to manage their digital identity in a confident, convenient and cost-efficient manner, including any or all of the digital resources that are associated therewith.

Within the financial and banking application market, the method and system of the invention may offer the opportunity to, for example, mutually authenticate senders and/or recipients of electronic transactions that take place across “multi-channel” banking networks. Whereas a large proportion of today's financial transaction services rely on interconnected electronic communication networks, many still lack strong user authentication capabilities. The proliferation of IP-based terminals and networks may therefore benefit. For example, the capability for corporate, private and retail banks to provide their consumers with a new authentication method and system may be implemented in a manner that does not change legacy “User Name+Password” experience of interconnected fixed and mobile “smart devices,” while allowing for a more advanced authentication service. Such implementations may significantly improve the overall security, convenience and/or cost-efficiency of IP-based, multi-channel banking operations, among others.

A method and system of the invention may also help migrate—in a smooth, transparent and automated manner—existing single-factor authentication services to two-to-three-to-“n” factor authentication services. To enable such a migration to take place, banking service providers may allow their consumers to enroll a variety of terminals and devices as new identification factors to be used to perform financial electronic transactions. Each banking consumer may then be enabled to use the terminal and device of choice to confidently, conveniently and cost-efficiently conduct multiple transactions over multiple banking terminals and networks.

A method and system of the invention may also offer reciprocal authentication services to lower the risks of so-called “phishing” attacks. In such a case, the legitimate owner of an enrolled terminal and device may be enabled to formally authenticate the legitimate identity of an enrolled IP-based or other server with which an electronic communication or transaction is to take place. Thus, network-based and e-mail-based banking, transaction and related services and operations alike may benefit from the advanced authentication services offered herein.

Together, banking and non-banking service providers may benefit from the anonymous credential management capabilities of the system. As the market for electronic services matures and increases the size and value of consumer databases, financial and non-financial organizations may want to share access to multiple user authorization tables. And since these tables may link to user identification and user authentication tables, privacy-based regulations and regulatory frameworks may limit the growth and scale of such electronic consumer-oriented databases and platforms. It is in this context, among others, that a method and system of the invention may be used and implemented by financial and non-financial organizations running or utilizing large-scale population databases. The invention may allow both types of organizations to access to databases of “anonymous” consumers, the back-end servers of the system storing the representation of the authentication credential issued to each consumer, this representation potentially impeding or preventing the reconstitution of the identity of each consumer.

Government institutions and agencies may chose to implement the new authentication method and system for both logical and physical access to sensitive resource. For example, some governments are notably reinforcing the control of their national frontiers via the issuance of advanced authentication means, including passports, electronic ID cards or other strong user authentication device form factors. These devices may support the storage, computation and display of several physical and logical identification factors such as a name, a picture, biometric traits, as well as several encryption keys that may be used for complementary authentication and electronic signature purposes at both citizen end-user and government server levels, among others.

In such a space, the implementation of a method and system of the invention may facilitate the issuance, usage and/or post-issuance management of “unique authentication numbers” provided to “unique individuals,” these numbers being generated using one or several of the physical and/or logical identification factors described herein. The computation and use of such unique authentication numbers may allow for an improved lifecycle management of the number and the nature of the identification factors used to generate the unique authentication number, potentially throughout the life of the individual. This unique number, which remains as persistent and irreversible as the identity of an individual may be retained through time and space, and may offer governments or other entities advanced capabilities to digitally manage the identity of individuals whose identification factors may have to evolve, de facto or de jure.

The usage of such unique authentication numbers, issued once to a unique person, may also help democratic societies to favor the vote of their citizens via the use of electronic terminals enrolled as identification factors that generate unique authentication numbers, each citizen being bound to his unique authentication number. The invention may enable, for example, the management of “anonymous votes” by individuals whose “personal identity” would have been authenticated when sending their respective unique authentication number to e-voting servers equipped with the new system functionalities.

This application may notably be of interest to governments or any legitimate authorities who want to assure themselves against the risks of voting servers being attacked for the purpose of digital identity re-engineering, theft or impersonation, as well as the purpose to link the various identification/authentication/authorization “tables” of a given electronic voting infrastructure. Since the implementation of an authentication method and system in accordance with the present invention, a given back-end server environment, need not allow for the storage of unique authentication numbers but only for the storage of their representation, the risks for re-engineering and/or reconstructing the digital identity of electronic voters can be lessened or removed, allowing voters' privacy rights to be protected in an advanced manner.

In another exemplary implementation, government applications that enforce citizens' privacy rights at an international level may be able to use the dual identity/anonymous authentication capabilities of the present invention to improve the verification processes of cross-frontier authorizations. By enabling the interoperability of the method and system of the invention with national passports and/or other ID cards used for cross-frontiers identification, authentication and authorization and other sensitive applications, national and international government agencies may be able to access and share “authorization tables” of individuals whose identity could remain anonymous. Potentially, the unique authentication number here could be used to validate national and international authorization rights of given individuals while enforcing, at the same time, the privacy of these given individuals to remain “anonymous.”

Also contemplated are applications of the invention in the telecommunications sector, which may be numerous and may answer the needs for new authentication methods and systems that may apply to the production, distribution, billing and/or maintenance of added value digital communications services.

As further discussed elsewhere herein, a system and method of the invention may fulfill new levels of data assurance requirements against the loss of professional, personal and other sensitive or “secret” data stored in mobile telephony, computing, entertainment and other data storage devices. When implemented, the system may offer a given user the ability to restore these data by using some of the identification factors that the user had employed when being issued a unique authentication number. Thus, a capability of the invention to restore lost secret or non-secret data may become an advantageous feature of next-generation mobile communication infrastructures and/or services.

The capability of a method and system of the invention to “federate” multiple identification factors into a unique authentication number may also leverage interoperability and continuity services of new communication and new content offerings such as Voice-, Video- and Data-over-IP services, as well as Video-on-demand, and also broadband- and mobile-oriented services such as WiFi- and IPv6-based services, among countless others, which may benefit from levels of advanced managed authentication services.

Accordingly, telecommunication service providers, among others who may position themselves as “Identity Providers,” may chose to offer an authentication method and system in accordance with the present invention as either a complementary feature of, or an alternative identity management method to, legacy Password-, SKI- and PKI-based managed authentication systems, for example. Whether introduced as an add-on or as a comprehensive alternative to existing authentication systems, the invention may improve the overall quality of Identity Providers' managed identity services.

By offering each of their consumers—corporate and private—the ability to enroll their electronic terminals and be provided with a “unique authentication number,” telecommunication providers and others may be positioned to offer the first universal authentication platform that federates, in a unified manner, the diversity of identification factors that have been—and continue to be—issued to individuals at an increasing pace. Such an approach towards a “strong,” “open” and “unified” authentication approach has notably been adopted by a number of industry vendors who joined the Open AuTHentication initiative (OATH), an initiative created in 2004 to facilitate collaboration among strong authentication technology providers. VeriSign, who led this initiative, played a key role in the developing “An Industry Roadmap for Open Strong Authentication,” information about which may be presently found at www.openauthentication.org. Many notable entities in relevant fields are believed to be participating.

In such a context, communication service operators, Identity Management solution vendors and electronic service providers, among others, may offer to their respective consumer, institutional and corporate markets a “unique authentication number-based” management platform that may streamline the issuance, usage and/or post-issuance management of authentication credentials based on key efficiencies enabled by the implementation of the present invention.

Further details and exemplary implementations will be provided below in a detailed description of embodiments of the invention.

### BRIEF DESCRIPTION OF THE DRAWINGS

Additional features and advantages of the present invention will become more fully apparent from a reading of the following detailed description of the preferred embodiment, along with the accompanying drawings, in which:

FIG. 1 illustrates an embodiment of an authentication system of the present invention;

FIG. 2 is a flowchart illustrating an embodiment of a method for fabricating an authentication device in accordance with the present invention;

FIGS. 3A and 3B illustrate exemplary workflows relating to an embodiment of authentication device activation in accordance with the present invention;

FIG. 4A is a flowchart illustrating an embodiment of a method for initializing an authentication device in accordance with the present invention;

FIG. 4B illustrates an exemplary workflow relating to an embodiment of authentication device activation in accordance with the present invention;

FIG. 5A is a flowchart illustrating an embodiment of a method for registering an authentication device in accordance with the present invention;

FIG. 5B illustrates an authentication curve in accordance with an exemplary embodiment of the present invention;

FIG. 6 is a flowchart illustrating an embodiment of a method for user authentication with an authentication system using an authentication device in accordance with the present invention;

FIG. 7 is a flowchart illustrating an embodiment of a method for re-registering an authentication device in accordance with the present invention; and

FIGS. 8-10 illustrate authentication curves in accordance with exemplary embodiments of the present invention.

### DETAILED DESCRIPTION OF EMBODIMENTS OF THE INVENTION

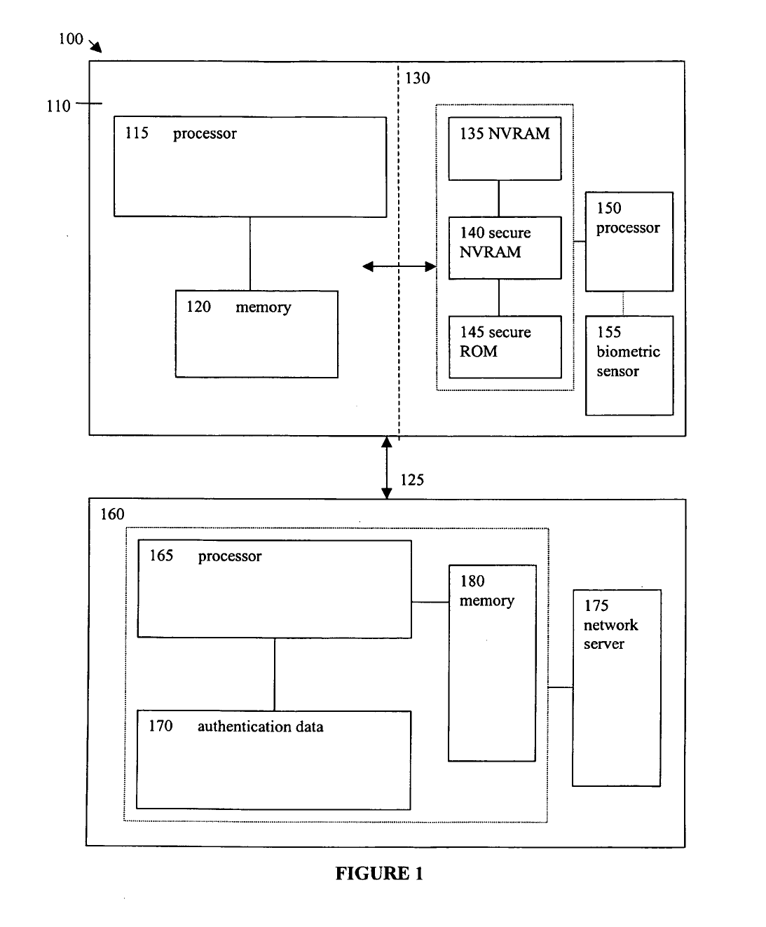

In one embodiment, an authentication device in accordance with the present invention is comprised of a portable, hand-held token, such as a USB (Universal Serial Bus) token. An embodiment of such an authentication device is represented as token 130, an aspect of an embodiment of a system 100, in FIG. 1. Such a token may be used in combination with a computing device 110, such as a personal computer, via a USB port.

Of course, an authentication device suitable for use in practicing the present invention could also take on a number of different forms and/or communicate with a system of the invention through a number of different protocols. For example, an authentication device may be a self-contained device including all required storage and processing capability, etc., and enabled for wireless communication with a network. Such a device may be useful in a system for enabling authenticated admission to a secured venue, among others. Additional forms of authentication devices include authentication tokens, smart cards, GSM (global system for mobile) devices such as with subscriber identification module (SIM) cards, personal digital assistants (PDAs), mobile digital assistants (MDAs), TV set-top boxes, PCs (personal computers), laptops, workstations or any smart card based devices. Such devices may use a USB (universal serial bus) interface for connected communications and/or Bluetooth or WiFi (wireless fidelity, e.g. IEEE 802.11) interfaces for mobile communications, among other means. They can be used in limitless applications, such as to give access to a computer system, open a door, a car door, to store and load personal user environments on computers, car seats and wheel positions, etc. Except where otherwise specified, “authentication device” as used herein may mean stand-alone devices like device 130 itself, combination devices such as processing system 110 in combination with device 130, or other variations.

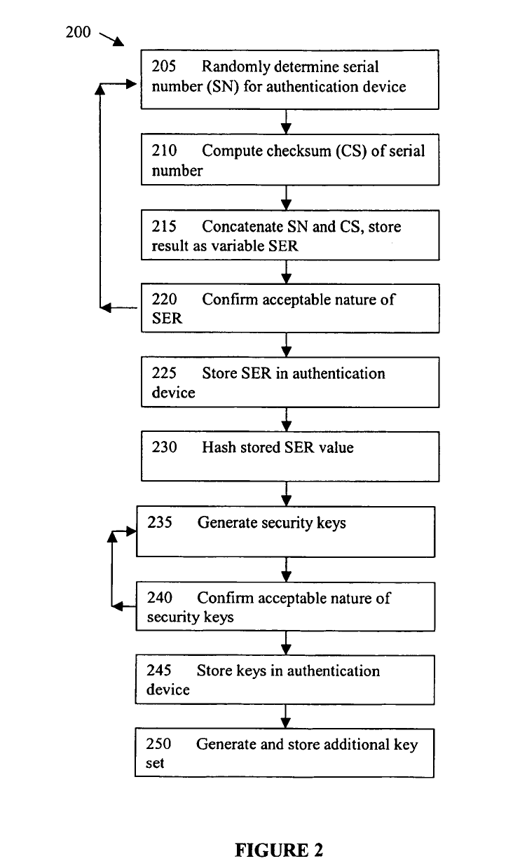

Referring to FIGS. 1 and 2, fabrication of an authentication token 130 is described. In FIG. 2, an embodiment of a method for fabrication is shown generally as a method 200. As with each method described herein, this method is meant to be illustrative rather than limiting. For example, as will be appreciated by one skilled in the art, each of the described steps need not be performed, as certain steps may be omitted and/or are subject to substitution with alternatives. Additionally, steps need not be performed in the described order, and additional steps that are not described may nonetheless be performed as a part of the disclosed methods.

In step 205, a serial number (SN) or other unique identifier is selected for the device. Such an identifier may be randomly determined, such as by a factory computer associated with the fabrication process, or other means known in the art. While termed a “number,” SN and all other variables discussed herein may include letters and/or other characters or identifiers. In step 210, a checksum (CS) is computed by applying a “CheckSum” function to the serial number SN, as will be appreciated by one skilled in the art. Then, in step 215, variables SN and CS may be concatenated, or appended to one another, with the result being stored in a variable Serial (SER).

In one embodiment, step 220 allows for the variable SER to optionally be screened for a special value that might make it more susceptible to improper means, such as tampering or decoding. This step may allow the system to determine that there has been no flaw in the generation of the serial number and/or its checksum. If desired or necessary, a new variable SER is generated in the manner discussed above. Once it is determined that the variable SER is acceptable, or if step 220 is not performed, the method continues with step 225. There, the variable SER is stored in the authentication device. SER may be stored in any suitable location, such as into secure Read-Only Memory (ROM) 145. Secure ROM 145 may be, for example, a non-rewritable, or “write-once” (and thereafter, read-only) memory area of the authentication device. This memory may be configured such that it can be read only by a processor 150 incorporated into the authentication device. This can be used to ensure that the data cannot be read directly by any other means. For example, a particular application programming interface (API) might be required, and even then, might only provide a coded view of the stored information. Thus, it is possible that, no entity, apart from the token itself, can access the information.

In one embodiment, in step 230, an optional additional measure of security is applied to the variable SER. For example, SER may be hashed to provide a value from which the original SER cannot be determined. That is, a hash function may be used to obfuscate values transmitted, such as to a host computer. In one embodiment, the non-hashed values are used by the authentication device to generate a user's data encryption key, or other values. Thus, it may be beneficial to ensure that other parties cannot access the values. Further, it may be desirable to avoid transmitting personal information of a user, such as the user's PIN number, for example.

In one embodiment, a hashing function represented by Hash0 is used to achieve a resulting value SERhash. As will be understood by one skilled in the art, the function Hash0 may be any suitable hash function. For example, the National Institute of Standards and Technology (NIST) Secure Hash Standard (SHS) provides such hashing algorithms as SHA-1 (Secure Hashing Algorithm-1). SHA-1 is among a family of known hash functions. Additional exemplary options include Message Digest (MD) algorithms, such as MD5, as well as algorithms and/or methodologies developed in the future.

Regardless of method used, the resulting value SERhash is stored in a suitable manner. For example, the value may be stored in secure Non-Volatile Random Access Memory (NVRAM) 135. Secure NVRAM 140 may be a read/write memory included in the authentication device, and may be configured such that it can be read and written only under control of the embedded processor 150.

In one embodiment, in step 235, another optional security measure is taken. That is, one or more pairs of encryption/decryption keys may be generated. As will be appreciated by one skilled in the art, such key pairs may provide for transmission of information to be usable only by an authorized recipient, may provide for a measure of authentication as a digital signature, and other features. Among suitable keys for use with the present invention are Public/Private key pairs available from RSA (acronym for developers Rivest, Shamir and Adleman). Such private and public keys are referenced as Priv (Tk) and Pub (Tk) herein, respectively. Typically, the public key allows for encryption of data such that it can only be decrypted by the corresponding private key. As RSA's public key encryption is well known in the art. If desired, the RSA key pair can enable a backup encrypted data exchange, such as between an authentication device 130 and a trusted third party (TTP).

As shown in step 240, the keys Priv (Tk) and Pub (Tk), like the variable SER discussed above, may optionally be checked to determine whether they exhibit qualities that might allow easier unauthorized decryption of data encrypted with them. If so, they are regenerated. If not, or if this step is omitted, Pub (Tk) is stored, such as into secure NVRAM. This memory may be the same NVRAM discussed above, but in embodiments in which the authentication device includes a processing unit of a personal computer, for example, it may also be a discrete memory area that may be configured such that it can be directly accessed by this processing unit. As shown in step 245, Priv (Tk) and Pub (Tk) may be stored in the authentication device in secure ROM 145.

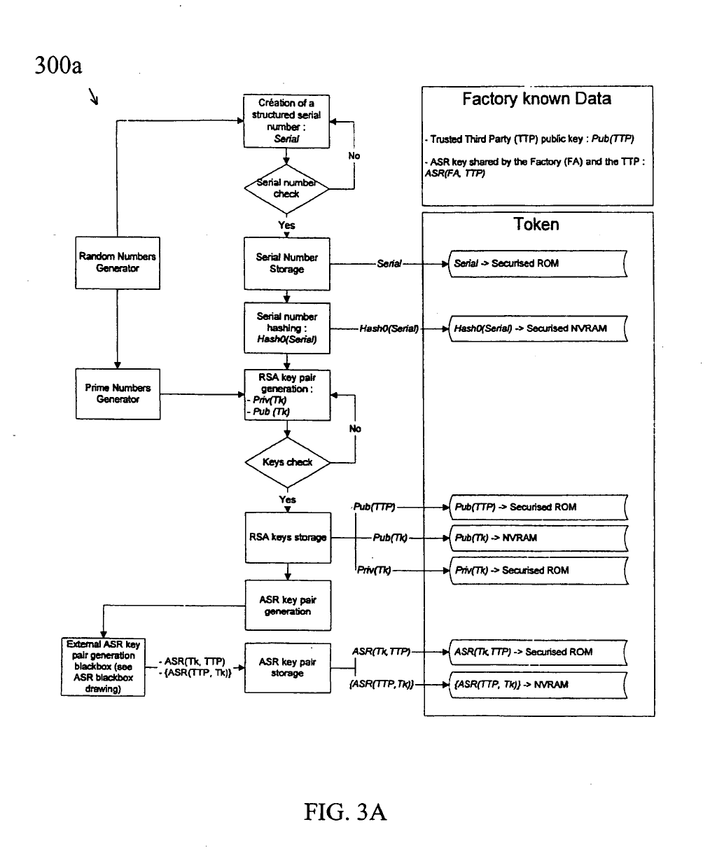

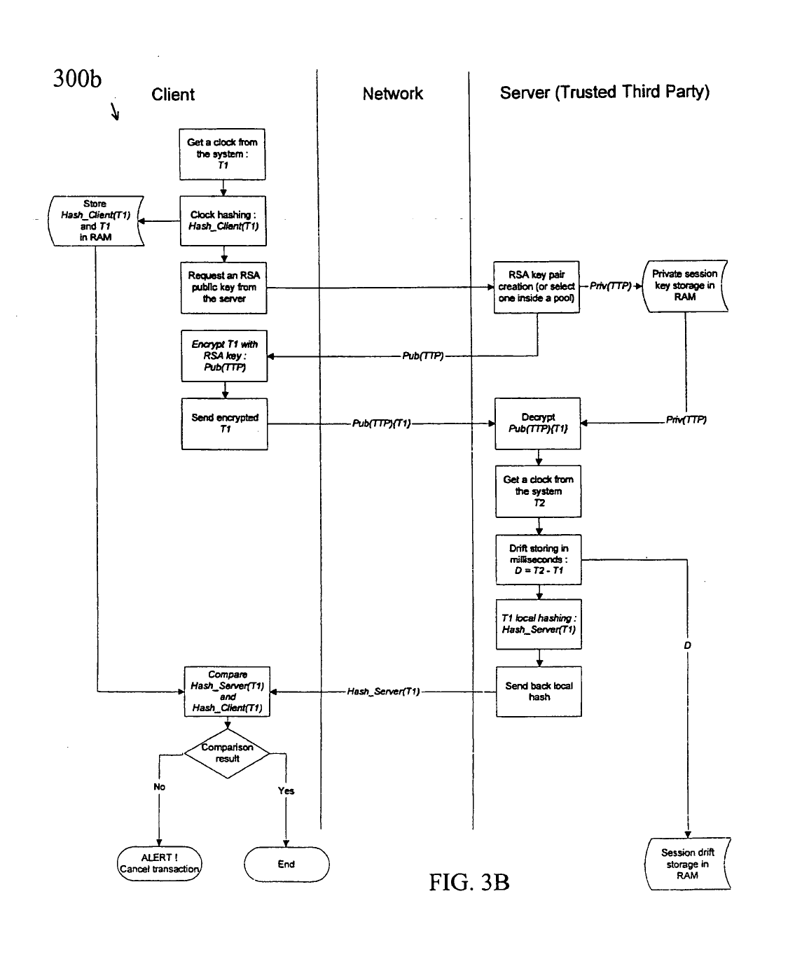

In step 250, yet another security measure may be taken. Alternatively, another pair of encryption/decryption keys may be generated that enables secure communications. In one embodiment, keys that enable Asymmetrical, Secret and Reversible (ASR) communications are generated. These keys are termed ASR keys herein. See process flow 300a in FIG. 3A and process flow 300b in FIG. 3B. They may be generated by an external “black box” ASR device and transmitted during fabrication of an authentication device of the present invention, or at another time through another means as desired. In one embodiment of ASR, if two parties desire to exchange messages, each must have a pair of half-public-private keys. For example, one party may have its own private key and the others public key, and vice versa. Thus, the system is asymmetric (the parties share no keys), secret (only each party possesses the keys to encode/decode a message of the other), and Reversible (two-way communication is enabled). RSA and elliptical versions of ASR are contemplated among others.

The encryption keys, whether they be ASR keys or others, may be used to provide a secure means for encrypted data exchange between an authentication device and a Trusted Third Party (TTP). In one embodiment, one key is used by the authentication device to encrypt data that will be decoded by the TTP using the corresponding key. As above, these keys, if opted for, may be stored as desired. A first key may be stored in memory, such as into secured ROM 145. An encrypted form of the corresponding key may also be stored, such as in NVRAM. In one embodiment, the same or a different key is used to encrypt data to be decoded at a system of the TTP using the key stored therein. In one embodiment, the completion of the foregoing steps marks completion of the factory fabrication of the token or other authentication device.

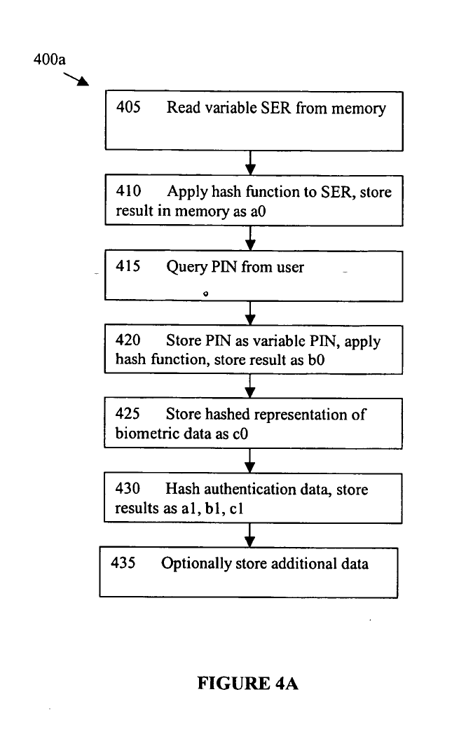

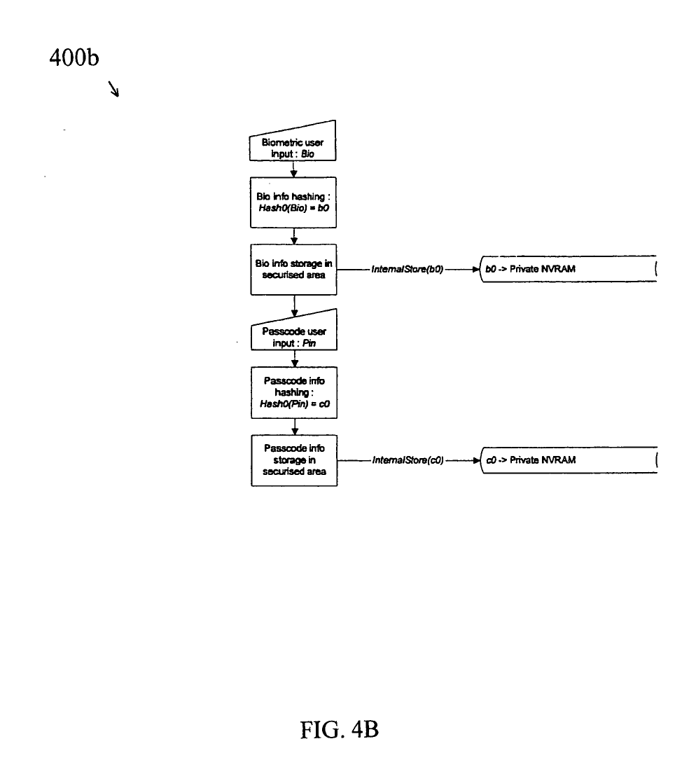

Referring to FIGS. 1 and 4A, an embodiment of an initialization procedure, illustrated as a method 400a, will now be described in the context of an embodiment of the present invention in which an authentication token is used. In such an embodiment, a user may be required to register with an authentication system of the invention to, in a sense, activate the token for future authentication activities.

In one embodiment, an authentication device is a USB token, optionally BlueTooth enabled, that can be conveniently purchased by a user, such as through the traditional retail market. If desired by the user, purchase can be made using cash or other non-traceable means such that the purchase is anonymous. It may be desirable that externally, each USB token is identical.

Considering an embodiment in which a USB token is used with a personal computer, once a user has acquired the token and is ready for its first use, the user may begin initialization by inserting the token into a USB port of the computer. Insertion can automatically lead to launch, on the user's computer, of a software interface program stored in the token. Such an interface may provide user-friendly and instructive assistance to the user in initializing the authentication device.

Once powered up, as shown in step 405, the processor 15 embedded within the token reads the variable SER from the memory in which it was stored, such as secure ROM 145.

In step 410, the processor 150 optionally applies a hash function, which may be the same function Hash0 discussed above, to SER and stores the result in a variable a0 in memory. Again, storage may be in the NVRAM 140 discussed above.

In one embodiment, in step 415, the processor 150 initiates, through the personal computer, a query for information from a user. This may be any information desired, such as a password, code or other known identifier. This can take place through a pop-up window, etc., generated on the user's computer screen by the software stored in the token and running on the user's system. Various requirements of the identifier, such as desired length, content, etc., can be designated at this time. The PIN may be received through a keyboard entry, as known in the art. It is assumed for purposes of illustration here that the identifier is a Personal Identification Number (PIN). Once entered, the PIN may be stored in a variable PIN. As represented by step 420, PIN is then hashed by the token's processor using Hash0 and stored in memory, such as secured NVRAM 140, as a variable b0. See also, process flow 400b in FIG. 4B.

Although not required, an additional piece of unique data may be required from the user. In one embodiment, this additional data is based on a biometric feature of the user. As an example, the token might be equipped with a biometric sensor 155, such as a fingerprint reader, through which the processor 150 can read fingerprint data. Like the PIN discussed above, entry of fingerprint data can be queried through the appropriate software. This data may be stored in a variable FingerPrint, hashed using an algorithm such as Hash0, and stored, such as in secured NVRAM 140, as a variable c0. See step 425, and process flow 400b in FIG. 4B.

As shown in step 430, the authentication data, such as SER, the PIN and/or the biometric data may also be hashed and stored in secure NVRAM 140 as temporary variables a1, b1 and c1, such as for transmission, as discussed elsewhere herein. One hashing function that might be used is Hash1, also from SHA-1. As will be appreciated by one skilled in the art upon a review of the present disclosure, the use of a hashing function distinct from Hash0 might offer certain benefits. For example, an unscrupulous party might otherwise, if access to hashed a0, b0, c0 and hash0 would be obtained, attempt to impersonate the true user. Instead, Hash1 may be used to hash the PIN and/or biometric information in real time, rather than using stored variables a0, b0 and c0. It may also used by the processor to extract a hashed version of the serial number SER. Thus, the three variables a0, b0 and c0 stored on the token in a secured area (and thus, non-readable by the user) may be used to authenticate the user locally (at the authentication device itself). Again, by avoiding storage of the true authentication values (except for the serial number) on the token, additional security may be obtainable.

This step completes token initialization in accordance with this particular embodiment of the invention. In an alternative embodiment, additional information might be gathered. For example, any of a variety of items of hardware information, software information and/or other data about the user's computer or other selected processor might also be obtained. As discussed below, such information might become useful during authentication procedures.

In one embodiment, an authentication token or other authentication device is set to perform a self-test at desired occasions before, during and/or following initialization by a user. For example, a self-test might be desirable at initial power-up of a token, such as when the token is interfaced with a personal computer or other processor. In one embodiment of such a test, the token's processor reads the variable SER from memory, such as secure ROM, and performs an internal consistency check on the serial number. For example, the processor might split SER into its origin serial number SN and checksum CS. Using the same initial CheckSum function, the processor can test whether SN results in CS. If not, the self-check fails, as this would indicate a potential security issue and/or hardware failure.

The processor might also read any or all of variables a0, b0 and c0 from their respective memory locations. By applying the appropriate optional hashing or other algorithms or methods to the respective variables, the device can confirm that the appropriate respective results are achieved. The self-test procedure might also involve re-entry of a user identifier, such as a PIN and/or biometric data. If any of these self-tests fails, a transaction might be terminated and/or an appropriate indication might be transmitted to a relevant server, such as to warn of a potential problem. Through these alternative steps and/or others of this nature, the authentication device my offer an enhanced degree of security.

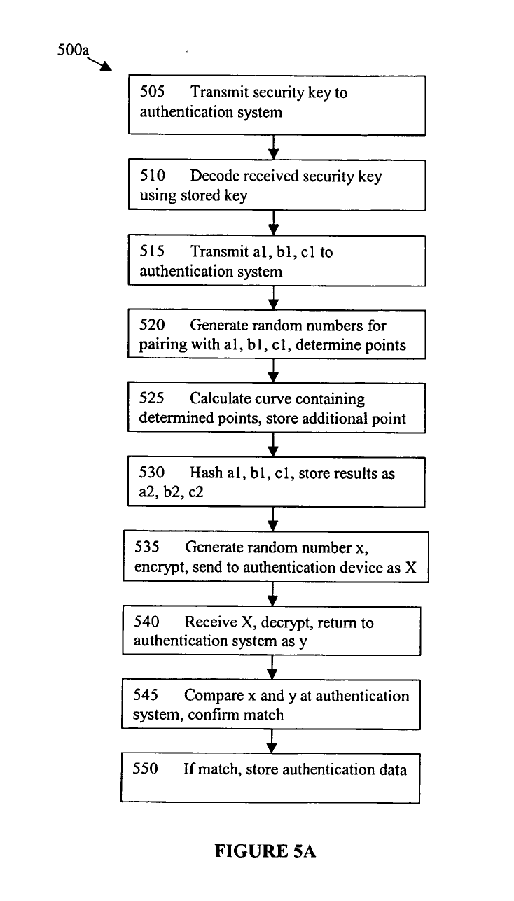

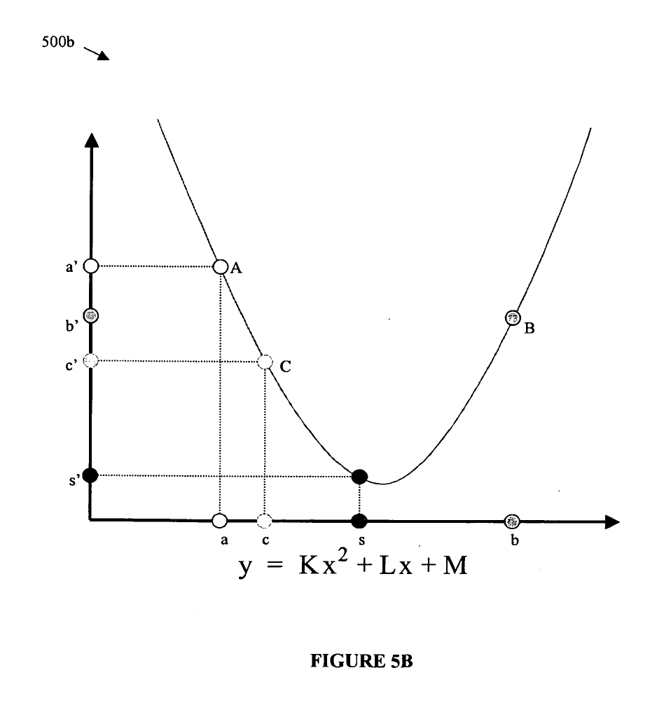

Referring to FIGS. 1 and 5A, an embodiment of a registration process of an authentication device with an authentication system, illustrated as a method 500a, will be described. Here again, for illustrative purposes and for consistence with the above discussion, an embodiment that includes an authentication token is assumed. For continuity, the authentication system will be referred to as TTP (Trusted Third Party). In step 505, while the token is interfaced with the user's personal computer or other appropriate processor, the processor within the token retrieves and sends to the TTP system, over a communication link 125, a key to allow future secure transmission of data. In one embodiment where a key is used, the key chosen is ASR key ASR (TTP, Tk) encrypted by ASR (FA, TTP), as discussed above, which can be retrieved from secure NVRAM and sent to the TTP computer system 160 having a server 175, using the processor 115 of the user's computer and appropriate communication link. However, as mentioned above, it should again be noted that many variations are contemplated. For example, the authentication device may itself be capable of transmission, such as a self-contained device enabled for wireless communication with a network, such as the Internet.

As represented by step 510, a processor 165 at the server 175 of the authentication system 160 receives the transmitted data through a communication interface. In one embodiment, the processor 165 decodes ASR (TTP, Tk), encrypted with ASR (FA, TTP), using ASR key ASR (TTP, FA) now stored in memory 180. The result of the decryption, ASR (TTP, Tk), may be stored in memory 180.

In step 515, assuming an embodiment where three data variables are required from the token 130, the token 130 retrieves and sends to the TTP server 160 the stored variables a1, b1 and c1 from secure NVRAM 140 and sends them to the TTP via the processor of the user's computer. Additional information, such as the user's computer hardware and other data, as noted above, might also be transmitted if desired. Such information might include connection information such as Internet Protocol (IP) or Media Access Control (MAC) address, Ethernet card number, or Internet Service Provider (ISP) server or proxy identifier; operating system; browser software and/or settings; clock data; display resolution or other audio/video settings; or data or settings related to manufacturing features, memory, peripherals, etc. This transmission may be encrypted using the TTP's public key or any other means of encryption.

In one embodiment, in step 520, processor 165 at the TTP associates these variables with others. For example, random numbers may be generated and paired with the received variables. Assuming variables a1, b1 and c1 are received, random variables a′, b′ and c′ may generated. These variables may then be paired to enable mapping of three points. These points are referenced herein as points A (a1,a′), B (b1,b′) and C (c1,c′). As will be appreciated by one skilled in the art, this nomenclature represents that a1, b1, c1 are the abscissas and a′, b′, c′ are the ordinates of points A, B, C, as in conventional geometry. See curve 500b in FIG. 5B.

In one embodiment, in step 525, the processor 165 at the TTP calculates a parabola that contains points A, B and C. That is, coefficients K, L, M are determined such that points A, B, C belong to the parabola defined by equation:
y=Kx²+Lx+M

Optionally, for backup purposes that will be discussed in greater detail below, an additional point S (s, s′), residing on the parabola, may be determined. In one embodiment, a random number is generated and designated as the abscissa s, from which a corresponding ordinate s′ is determined from the equation:
s′=Ks²+Ls+M
This point S (s,s′) is then stored at the TTP location.

In step 530, the variables a1, b1 and c1 are optionally hashed for storage. Hashing has been discussed above. One appropriate algorithm is Hash2, resulting in variables a2, b2, c2. Variables a1, b1, and c1 may then be discarded. By failing to maintain these variables in storage, a risk of theft or other unauthorized use of this information can be reduced and a security of the overall authentication system improved.

In one embodiment, in step 535, another random number is generated and stored in a variable x. The variable may be encrypted, such as by using ASR key ASR (Tk, TTP), and stored as an encrypted variable X. This variable may be sent to the authentication device, in this case the authentication token.

If transmitted, the token receives the value X In step 540 and decrypts it, using ASR key ASR (Tk, TTP), and stores it as a variable y. This variable y is then returned to the TTP server, which compares it to the value x. See step 545. If these values differ, then registration of the authentication device fails. If there is a match, registration succeeds, and in step 550, variables a2, b2, c2, a′, b′, c′, S and ASR (TTP, Tk) are stored, such as in an Authentication Table 170 or memory unit 180, thereby completing registration.

As noted above, received variables a1, b1 and c1 need not be stored. Rather, they may be maintained only long enough to determine a2, b2 and c2 to determine a curve and calculate a desired result to be used for authentication. The result may require matching the curve and a stored point. Alternatively, the result may involve determining coefficients of the curve. As yet another alternative, the relevant result might be derivative from one or more of the above results or others. For example, in one embodiment, upon calculation of variables K, L and M in the above equation, a variable G may be determined from the formula:
G=KoLoM
with this result being used for authentication. This variable G may be referred to herein as a “Genonym.” In one embodiment, the function “o” is a one-way destructive and non-reversible function. That is, even knowing G, it would be impossible to retrieve K, L and M. Function “o” can be a hash function, a summation, a multiplication, etc. This may also be referred to herein as ƒ(K, L, M). Thus, many authentication methods are contemplated in accordance within the present invention.

In one embodiment, the present invention provides an authentication system using an authentication variable G, the authentication server only stores 1) a hash or other representation of each of the abscissas used in generating an authentication curve (as an entry point to a first table, and alone from which, authentication data cannot be regenerated), 2) randomly selected ordinates corresponding to the abscissas (such that, when the abscissas are received, the authentication curve can be rebuilt), and 3) a back-up or safety point. In one embodiment, when a curve is calculated, its equation can be found, leading to its parameters or coefficients. For example, in the case of a second degree curve, Kx²+Lx+M, one can compute K, L and M, from which a unique ƒ(K, L, M) can be calculated as the user's unique identifier (whatever ƒ is). This identifier may then be used to map to an external authorization table, an external identification table, user's keys or certificates, etc. Thus, even if the authentication server is compromised in such an embodiment, it would not contain-enough-information to determine ƒ(K, L, M).

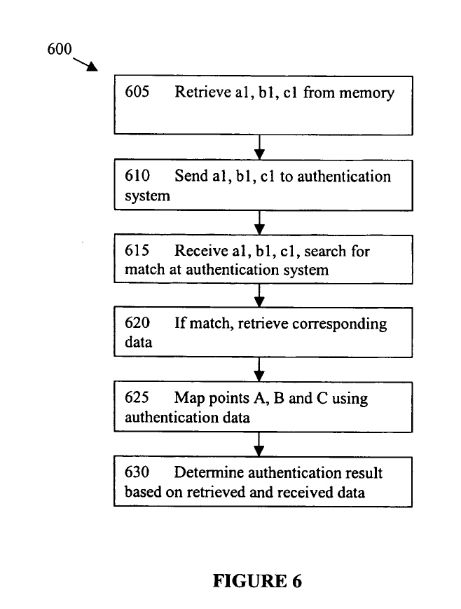

Referring to FIGS. 1 and 6, an embodiment of an authentication procedure involving the user and token 130, illustrated as a method 600, will be described. Such a procedure might be utilized when, for example, a user desires to conduct a sensitive transaction, perhaps a financial transaction. In such a case, the present invention can provide an authentication service to the relevant financial institution.

In one embodiment, in step 605, assuming three data values are required, the token retrieves a1, b1 and c1 from its secure RAM 140 and sends them to the TTP server. Of course, one or more of these values may need to be provided by a user at a relevant time, rather than retrieved from memory, for example. The server may apply a relevant hash function, which in this case is assumed to be hash2, to values a1, b1, c1. See step 610. The resulting values may be stored as temporary variables a2, b2, c2. These variables may be searched to determine whether corresponding values are present in the Authentication table.

In step 615, it is determined whether a match was found. If not, authentication fails. If a match is found, the values a′, b′, c′, S and ASR (TTP, Tk) are retrieved from the relevant Authentication Table entry. See step 620.

As shown in step 625, the processor 165 at the TTP location may map point A having coordinates (a1,a′), point B having coordinates (b1,b′) and point C having coordinates (c1,c′), and is then able to compute coefficients K, L, M such that parabola defined by equation
y=Kx²+Lx+M
passes through points A, B, C, as discussed above.

In one embodiment, in step 630, the processor 165 computes the expression Ks²+Ls+M using s, the abscissa of point S, and it compares the resulting value to s′, the ordinate of point S. If the values differ, authentication fails. If there is a match, authentication succeeds. Other embodiments may use varying calculations as a test of authenticity.

In accordance with the above method and other contemplated for practice of the present invention, a means for anonymous authentication may be achieved. For example, in conducting a network transaction, it might be the situation that a user need only confirm to a party carrying out the transaction that the user is the appropriate party for the transaction. The user need not be specifically identified in the manner that identification is commonly understood. One need only know that the user is the appropriate party, not who the user is.

Of course, numerous alternative authentication methods are contemplated. As discussed above, in one alternative embodiment, a variable G=K o L o M is calculated. In this embodiment, the variables a1, b1, c1 received by the authentication server may be used, as in the registration process, to generate three points, a corresponding parabola including coefficients K, L and M, and to calculate a variable G. Thus, as described herein, authentication might be based on a match or other relationship between any of a variety of indicators.

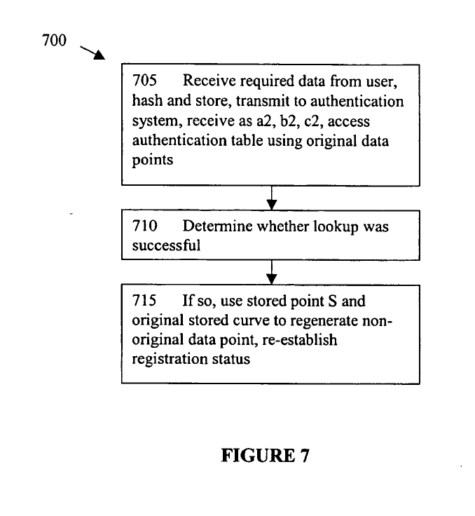

Referring to FIGS. 1 and 7, a re-registration procedure will be described. Such a procedure might be useful or required in the event of a lost authentication device, or the loss of certain data. In the context of the embodiments discussed herein, data loss might result from a lost or forgotten PIN, a changed fingerprint, etc. The case of the forgotten PIN is selected as exemplary for purposes of illustration.

In one embodiment, the initial steps of re-registration are analogous to those related to the original entry of a PIN during registration. That is, upon activating an authentication device, the user might be asked to enter a PIN, which is hashed and stored as desired in one or more memories of the device. The hashed representations of the PIN and other data, such as the serial number of the device and some biometric data, are obtained at a relevant time and if confirmed, and sent in encrypted form to the authentication server. In an embodiment requiring three forms of data, the data is sent as a1, b1 and c1, where b1 represents the new PIN. As discussed above, the hash function Hash2 may be applied to these variables, with the results being stored as a2, b2 and c2. These initially duplicative steps are collectively represented by step 705 in FIG. 7.

In the case of a valid re-registration, variables a2 and c2 should correspond to variables stored in the Authentication Table 170. Thus, one step might include a lookup in the Authentication Table 170 for these values.

In step 710, it is determined whether the lookup was successful. If not, re-registration fails. But if so, as in step 715, stored points a′, b′, c′ and S (s,s′) corresponding to a2 and c2 are retrieved from the Table. Points A (a1, a′) and C (c1, c′) are then regenerated and, in a manner discussed above, coefficients K, L, M calculated such that the parabola defined by equation
y=Kx²+Lx+M
passes trough points A, C, S. From this, the system can compute a new ordinate b1′ for point B using the formula b1′=Kb1²+Lb1+M. Values b2 and b′ may then be used to replace previous values at location associated with the matching a2 and c2 above, and the re-registration process is completed. Of course, depending on a degree of reliability desired, additional information might be required of a user who claims to be re-registering. That is, additional steps might be taken to verify a user's credentials. For example, in one embodiment, complementary authentication data, such as the hardware data of the user's computer or other information, might be sent to the authentication system as an additional or alternative means of verifying that the proper user has accessed the authentication system.

By the above methods, a user can maintain an original set of authentication information even though one of the original bases for a data point has been lost. Likewise, re-registration is possible in a case of a changed fingerprint, a changed serial number such as when an authentication device is lost, etc. Moreover, such features of the invention may enable a user to maintain a single authentication variable G, or Genonym, with the authentication system, although through time the user may change any or all of his or her items of authentication information one or more times.

Now, for purposes of further explanation regarding use of an authentication variable, or Genonym, a mathematical “proof” will be provided regarding possibility of one obtaining the Genonym without all required identification variables. For purposes of this explanation, it is assumed that abscissas x1, x2, x3 of an authentication curve are calculated by hashing (e.g., SHA-1) starting from the user's identification data, and that x1, x2, x3 are exchanged (with or without encryption) over the network. It is further assumed that these data all are lower than a choosen large prime number p (the choice of p may be related to the choice of the hash function). It is further assumed that an authentication server stored only the corresponding ordinates: y1, y2, y3, as well as the coordinates of a safety point, S=(xs, ys), comparable to an embodiment described elsewhere herein.

For purposes of this explanation, it is assumed that calculations are made modulo p, with abscissas and the ordinates related to an authentication curve having values in the Z/pZ field (i.e., integers modulo a prime number p). As a result, the operations enabling calculation of an ordinate of a point of the curve, or determination of the coefficients of the curve from 3 points, are assumed here to be limited to addition (+), subtraction (−), multiplication (×) or division (/), in any field. As a result, only integer numbers will be considered here; curves having an equation y=kx²+1x+m now appear as groups of points; and there are p³−3 curves that could be a resulting Genonym, because the p lines of equation y=m (parallel to axis ox) are ignored while all other lines (k=0 and L not equal 0) are considered, as are parabolas where k is not equal to 0.

It is now assumed that a hacker or other ill-meaning entity has obtained all abscissas transferred across the network. The function x→kx²+1x+m is defined in the entire space Z/pZ. Thus, any set {x1, x2, . . . xn} of integer number modulo p can correspond to the abscissas of points of any curve, and a set of abscissas, as large as it may be, does not give any information on the curve. The hash functions are such that the knowledge of one of the abscissas does not make it possible to recover any information on corresponding ordinates. In one embodiment, effort is undertaken to ensure that small data is not hashed alone, but rather, it is always accompanied by potentially large data (large enough to prevent the construction of an exhaustive table of hashed values, as otherwise discussed herein).

It may also be assumed that a would-be hacker has observed and stored all ordinates in an identification table since its inception, such as where an entity has obtained an entire table and its history. Thus, a given entity might possess a set of ordinates {y1, y2, . . . yn} and coordinates for a safety point S. However, in this case, most functions x→kx²+1x+m are not surjective, mathematically speaking, on Z/pZ (e.g., only linear applications are surjective, but the probability that G is a line is 1/p, i.e., quite unlikely).

Thus, theoretically, a potential hacker would begin eliminating each curve that does not reach one of the ordinates yi (or which does not include the safety point S). In the hypothetical case where one manages in an effective and time limited way to eliminate all these curves (the algorithm however remains to be found), even were it to be suggested that every possible G could be determined, it will now be illustrated that a proper G cannot be found.

The following hypotheses are made: P a degree 2 polynomial with coefficients in Z/pZ; S a point of the curve representative of P; Y the image of Z/pZ by P. If so, there are in general at least (p−2) polynomials with a degree 2 for which the image of Z/pZ is Y and of which the curve representative passes by S, except in a particular case where this number is brought back to (p−3)/2. In other words, a hacker who knows ALL ordinates “reached” by the curve and all coordinates of the safety point S would nevertheless experience ambiguity between least p/2 curves having an equal probability of being the correct choice.

The data here is as follows: P is a polynomial defined by P(x)=ax²+bx+c, with coefficients in Z/pZ (where <<a>>) is non-null); S (xs, ys) is a point of the curve representative of P. Here, if E is a subset of Z/pZ and k an element of Z/pZ, the set obtained by adding k to each element belonging to E is designated by k+E; the set obtained by multiplying k by each element belonging to E is designated by k E.

Quadratic residues are as follows: R* indicates the set of the quadratic residues modulo p.(the set of the non-null squares); R′* indicates the set of non residues (non-null); R=R*U {0}; R′=R′*U {0}. For a non-null, Ra* indicates the class of “residuosity” of a: Ra*=R* if a is quadratic residue; Ra*=R′* if not; Ra=Ra*U {0}. It is known that: cardinal R*=cardinal R′*=(p−1)/2; the product of two elements from R, or from R′, belongs to R; the product of one element from R with one from R′ belongs to R′. In addition, it is noted that Y is the image of Z/pZ by P. Properties of Y are as follows: If M(xm, ym) is “the extremum” of the curve representative of P, more precisely, xm=−b/2a, ym=P(xm), the equation of the parabola can be rewritten as: y−ym=a(x−xm)₂.

As the function x→x−xm is bijective (i.e., mathematically injective and surjective) and (x−xm)² is a quadratic residue or equals zero, it can be deduced that: Y=ym+Ra. Consider the set of polynomials P_{a′,k} defined by P_{a′,k} (x)=ym+a′(x−xm+k)². With a′ an element of Ra** and k an unspecified element of Z/pZ, Y′, the image of Z/pZ by any of these polynomials is also Y′=ym+Ra. The image of Z/pZ by any of these p(p−1)/2 polynomials is thus Y and all these polynomials are appropriate.

Attempting to choose a proper parabola from among parabolas that each pass through S and that “reach” the same ordinates as the curve representative of P, an unspecified element a′ from Ra* is chosen (there are (p−1)/2 possible choices including a). Then, to calculate k so that the corresponding curve passes by S, the following would need to be solved: ys=ym+a′(x−xm+k)² or (ys−ym)/a′=(x−xm+k)². The second member of this equation is an element of R. The first member of the equation is null, or is the product of two elements from R′. It is thus also an element from R. Since this first member is also a square, the equation generally has two solutions except when ys=ym in which case it has only one of them. If S is different from M, there have been built (p−1) parabolas that answer the requirements (p−2 if one excludes the initial parabola). If S and M are the same, built (p−1)/2 parabolas have been built.

Thus, even the knowledge of a very large number of abscissas (such as in a case where an entity observed all exchanges between a given authentication device and server) is not enough to reconstruct the curve. Similarly, the knowledge of a very large number of ordinates and a safety point “S” (as in the case of an entity knows an entire history of server table modifications) is not enough to reconstruct the curve. Thus, the invention may be implemented in a way that renders it mathematically impossible to reconstruct the curve by calculation.

Now, to expand upon other disclosures herein, it should of course be appreciated that the inventions described herein need not be practiced as detailed above, as numerous variations are contemplated. In one embodiment, the authentication device sends 3 parameters. These parameters are used with 3 values (e.g., random numbers or otherwise) stored, such as by the TTP, allowing 3 points to be generated or regenerated. A polynomial curve of the second degree (parabola) can be used, with 1 safety point being stored, such as by the TTP.

More generally, additional embodiments may be described as follows—P parameters may be used with P random numbers to rebuild P points: Q₁, Q₂, Q₃, . . . Q_{P}, to support a polynomial curve of degree D (defined by D+1 points). Additionally, S safety points Sec₁, Sec₂, Sec₃ Sec_{S} may be determined. In such an embodiment, in generating the curve of degree D, it is assumed that S<D+1. Since S+P, the total amount of points available, may allow the curve to be rebuilt, S+P should be greater than or equal to D+1. Defining the number of extra or redundant points as redundant points R, R may be defined by the difference between the number of available points (S+P) and the number of points (D+1) needed to reconstruct the relevant curve. That is:
R=(S+P)−(D+1)

The so-called redundant points R, in whole or in part, may be used as additional authentication parameters, such as to improve reliability and/or security during an embodiment of an authentication procedure as described herein (where the redundant points belong to the authentication curve constructed using the other points), or to compensate for lost parameters (such as in a case of a re-enrollment, also described herein).

As discussed herein, in one embodiment of an authentication system in which an enrollment process is used, and in which a TTP or other host is utilized, the TTP may store certain data. Based on such enrollment, the TTP may generate a table or other data storage format having entry points, indices or other locators, preferably including values based on hashed or otherwise obscured versions of authentication parameters P and safety point data. As discussed above, the parameters P may correspond to P ordinates. The safety point data may be coordinate data.

In one embodiment, during an authentication procedure, an authentication device transmits the P obscured parameters to a TTP, which uses one or more of them to find an entry point into an identification table. The TTP may use the P parameters as abscissas, and use corresponding data from the identification table as ordinates to determine P points. If safety points are present, S safety points plus P points provides S+P points on an authentication curve. The TTP may use D+1 of the points to determine the curve, while additional points found on the curve would not be necessary at that time.

In such a case, in one embodiment, a user might be authorized to lose L parameters, where:
L≦(S+P)−(D+1)
That is, L is less than or equal to the number of redundant points. During authentication or other connection to the TTP or other relevant third party, where one is involved, the party may only be provided P−L+S points. As P−L+S is greater or equal to D+1, the curve, and thus, the Genonym, can be rebuilt. Where parameters have been lost, using the equation of the generated curve, the TTP or other party may compute the new ordinates, abscissas, etc., as needed, corresponding to new parameters sent by a user in place of the lost ones. The TTP may then modify the identification table or other data storage location accordingly.

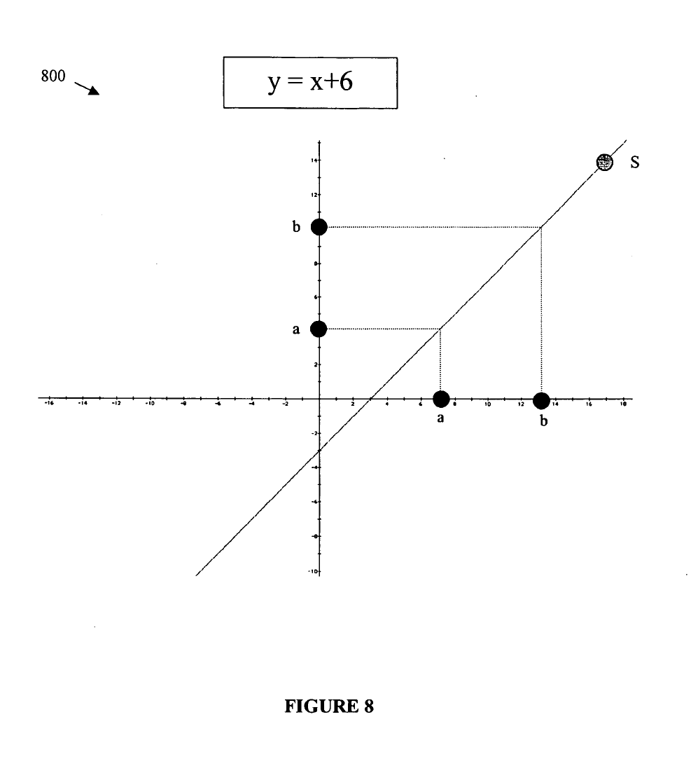

For illustrative purposes, certain specific examples will now be described with reference to FIGS. 8-10. Referring first to curve 800 in FIG. 8, an embodiment is shown in which 2 parameters and 1 safety point are used. In this case, a curve of the first degree (e.g., a straight line) is obtained. In this exemplary case, the curve is defined by y=x+6. Here, R=1, so a single parameter may be lost and the curve may nevertheless be recovered.

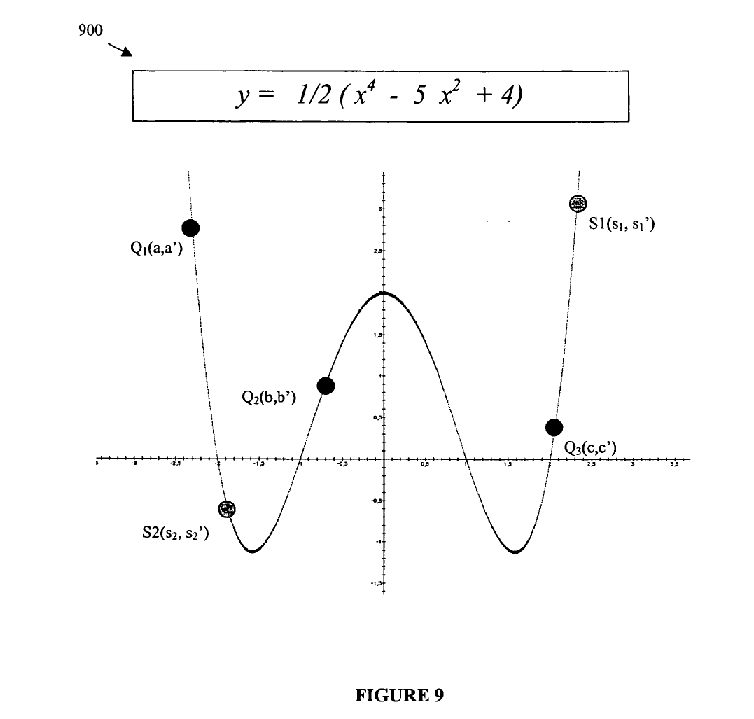

In the next example, illustrated as a curve 900 in FIG. 9, an embodiment is shown in which 3 parameters and 2 safety points are used. In this case, a curve of the fourth degree is obtained, defined in this exemplary case by ½(x⁴−5x²+4). Here, R=0, so no parameters may be lost while allowing the curve to be recovered.

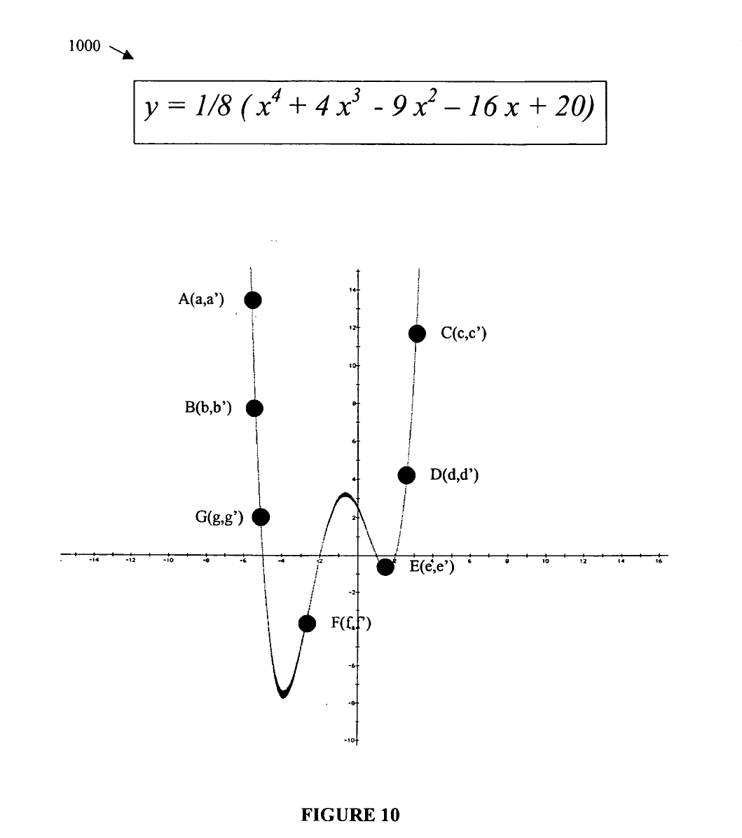

In the next example, illustrated as a curve 1000 in FIG. 10, an embodiment is shown in which 7 parameters and 0 safety points are used. As above, in this case, a curve of the fourth degree is obtained. The curve is defined in this exemplary case by ⅛(x⁴+4x³−9x²−16x+20). Here, R=2, so 2 parameters may be lost concurrently while allowing the curve to be recovered.

For further illustrative purposes, an exemplary implementation of the above described systems and methods will now be described. As used herein unless otherwise noted, the following shorthand will represent the corresponding functions: h(x)=SHA1(x); h0(x)=MD5(x); h1(x)=MD5(SHA1(x)). As discussed above, in one embodiment each authentication device is fabricated with a unique serial number or other identifier denoted SER. For each manufactured device, it may be desirable to generate in a database or table, a line containing the values shown in table 1.

TABLE 1

| | |
|---|---|
| COM₁ = SHA1(SER) = h(SER) | N0₁ = MD5(SER) = ho(SER) |
| COM₂ = — | N0₂ = — |
| — | — |

The table may be incremented and updated as each new device is generated. Optionally, the obfuscated values may additionally stored, such as in a database or table, incremented and updated as additional authentication devices are generated. In one embodiment, h(SER) and ho(SER) are stored together in a single line, the values being designated as COM and N0 for future reference. These values may be securely transmitted to an authentication server (as further discussed below) for future authentication purposes.

Assuming an example in which a user acquires an authentication device for use with a PC and in which biometric data is not used, the user may desire to enroll or register with an authentication system in order to enable future transactions. The user may be asked to communication to the authentication system a secret password (PSWD) known only to the user. During enrollment, the user may initially provide this information only to the device itself, an internal program of which calculates a hashed version thereof. This program may also calculate a hashed version of SER and of data of the PC, such as a MAC address, as discussed above. For this example it is assumed that the following are data are determined and transmitted to the authentication server:
N0=ho(SER)
N1=h(PSWD)
N2=h(SER-MAC)
N3=h(SER-PSWD)
N4=h(MAC)

Receiving this data, the authentication server begins by verifying that there is an entry N0 in the database or table previously received. If not, the device is likely not authentic and the user's access should be denied. If the entry is found, however, the device is deemed authentic and the corresponding data entry (COM=h(SER)) in placed in a new line in a table accessible by the server. The initial line may be deleted, such as in an effort to prevent false duplication.

As an initial step toward generating an authentication curve, the server may now generate three random numbers (A, B, C) that will act as three coefficients in the curve, assumed here to be a second degree curve (parabola). Thus, in accordance with the description above, this would result in an authentication curve y=Ax²+Bx+c and a Genonym G=h(abc). In addition, the following additional values may then be calculated and stored, such as in the table: I1=h(N1)=h(h(PSWD)); I4=h(N4)=h(h(MAC)); thereby allowing future identification as discussed below.

For each value (N1, N2, N3, N4) received by the server and taken as abscissas, the server may then calculate the corresponding ordinate as follows:
N1′=(A*N1)²+(B*N1)+C
N2′=(A*N2)²+(B*N2)+C
N3′=(A*N3)²+(B*N3)+C
N4′=(A*N4)²+(B*N4)+C
   These values may be stored in the table with a safety point S (s,s′) determined from a random point on the curve, as discussed above, thereby completing enrollment in accordance with this embodiment of the invention.

Thereafter, when the user desires authentication, the user again provides the secret password to the authentication device. Based on calculations discussed above, the device then provides, for example, two data items N3(h(SER-PSWD)) and N4(h(MAC)) to the server. With this data the server can calculate I4(h(N4)) and verify that such an entry exists in the proper table, and if so, can retrieve N3′, N4′ and S. Utilizing the three resulting points (N3,N3′), (N4,N4′) and (s,s′) to generate a curve based on the formula y=Ax²+Bx+C, the server can calculate G (that is, h(ABC)) and retrieve the value COM (h(SER)) from the table.

In this embodiment, the server then generates a random number RND and, with encryption optional, sends it to the authentication device. The authentication device is thereafter able to calculate the following: V1′=ho(h(SER)−RND); V2′=h(h(SER)−RND); with at least one of the values, say V1′ being transmitted to the authentication server. If V1′ matches V1, then the identity of the authentication device is confirmed and the user is considered to be authenticated. Thereafter, a reliable key match V2=V2′ can also be relied upon without requiring this information to be transmitted over a network.

For purposes of further illustration, a situation in which the user desires to register a different computer for use with that authentication server will be described. In such a case, the user may, as described above, be asked to provide a password, from which N1 and N3 above may be calculated. In this case, however, N2 and N4 will change because these values, in the described embodiment, utilize a MAC address of the computer. Nevertheless, based on I1 (h(N1)), the server can detect a match in an authentication table or other resource, and retrieve N1′, N3′ and S. Based on determined points (N1, N1′), (N3, N3′) and S (s,s′), the server can again determine G and authenticate the user. The server can also determine a modified 14, and if the user desires to permanently register the newly-used computer, modified ordinates corresponding to modified variables N1′and N3′ can be determined and saved. Otherwise, such as in the case of a one-time transaction from a foreign computer, this information may be purged following the transaction.

A similar methodology might be utilized when a user has lost or desires to change one of the data points used by the system. For example, if a user has forgotten his or her password or otherwise would like to change it, the situation may be remedied in a relatively convenient manner. In one embodiment, even if a user has lost his or her authentication device, the situation is recoverable. In such an embodiment, after obtaining a new device, the user may be required to access a computer that has previously been used and registered with the authentication system, thereby maintaining any data points based upon the computer's MAC address or other comparable identifier. Again, the device may transmit four items of data N1, N2, N3 and N4, this time with N2 and N3 (the points being dependent on a serial number SER of the device) being changed from a prior transaction. The server may then locate N0 in an authentication table, as discussed above, but this time if an entry is found it may be desirable to delete the entry after the associated data is retrieved. The retrieved data can be used to regenerate a curve and recalculate and replace with new values for N2 and N3.

As noted above, it may be desirable in some implementations of the present invention that an authentication device be enabled for storage of data. For example, an authentication token may retain data (e.g., password, PKI (Public Key Infrastructure) and/or SKI (Symmetric Key Infrastructure) keys, certificates, etc.) used, for example, in connecting to an authentication server. For illustrative purposes, it will be assumed that such data may be stored in a file or partition denoted PERSO.

In one embodiment, the authentication device creates an encryption key denoted KEY=(SER-PSWD-MAC). The device also creates an “image” of this key denoted RETR=(h1(SER) XOR h1(PSWD) XOR h1(MAC)), where “XOR” represents the ExclusiveOr logical function. The device may then encrypt this data. Assuming AES (Advanced Encryption Standard), for example is used, [PERSO]_{key}=AES(PERSO,KEY) is obtained. The device may then save the a corresponding file [BACK]_{key} at another location, such as on a server, computer, etc. The authentication device may then save the file RETR on the Genonym server, along with the authentication table. Thus, in one embodiment, an authentication table entry for a user may include G=h(ABC), COM=h(SER), and RETR.

If desired at a later time, the user may access the authentication device, such as by connecting it to a registered computer if required. Using the computer's information (e.g., MAC) and/or personal information (e.g., PSWD), the device is able to calculate K1, K2, K3 and KEY, where K1=h1(MAC); K2=h1(SER); K3=h1(PSWD); and KEY=(K1, K2, K3). The device can then decipher the partition [PERSO]_{key}; PERSO=AES([PERSO]_{key}, KEY). The device can then access the partition (PERSO) as desired, without requiring access to a server. Thus, the authentication device can be enabled for storage of any information desired by a user, with subsequent changes being encrypted and saved as needed.

In the event a user has lost the password, the authentication device, assuming usage in the embodiment described above, would be able to calculate K1 and K2, but not K3, and therefore could not calculate KEY. In this case, the user may be asked to log in on the server as above using a new password, denoted PSWDnew. The server sends back the key RETR to the device, which may then calculate the following using RETR: K3=RETR XOR K1 XOR K2; KEY=(K1, K2, K3). It is then able to decipher the partition PERSO=AES([PERSO]_{key}, KEY), and can access the partition PERSO as desired. When completed, the authentication device can create a new and updated cipher key as follows: K1=h1(MAC); K2=h1(SER); K3=h1(PSWDnew); KEY=(K1, K2, K3). The device may then create an “image” RTF of this key, namely RETR=(K1 XOR K2 XOR K3). As above, the device may cipher these data in AES using [PERSO]_{key}=AES(PERSO,KEY), and save the file [PERSO]_{key} on a server, computer, etc. The device is able to update the image RETR on the Genonym server, along with the authentication table, as desired. In an alternative embodiment, in the event a user elects to change computers (where one is required), the process may in one aspect be as explained above, with the exception that the value for MAC should be updated, rather than the value for PSWD.

In yet another embodiment, it is assumed that the user has lost his or her authentication device. In that case, the user may connect using a registered computer. The replacement authentication device may then retrieve the encrypted partition [PERSO]_{key} and install it in the new device. The process described may otherwise remain the same as previously described. Such a capability may offer advantages in certain situations or implementations. For example, in an embodiment applied to a card (e.g., smartcard, credit card, bank card) or other possession, if the item is stolen, found or otherwise obtained, the entity now possessing it can fraudulent use (in the case of a card, for example) the number, name, security code, etc. The original owner might be required to cancel the card, with all associated data being deleted from an associated server and requiring that a new card be manufactured, issued, initialized, etc., often a time consuming and expensive process. In accordance with the present invention, however, one who finds the card cannot use it and/or access any protected information stored thereon or accessible thereby without having the required distinct data items. Thus, if the relevant item is lost in that case, it is enough to merely reinstall the ciphered file PERSO on the new item, and cancellation, remanufacture, reissue, etc., could be avoided.

Thus, in accordance with the description provided above, the invention may offer an authentication device through which a user may safeguard personal or otherwise sensitive data. In the context of the examples given, even if a person other than the user were to have access to RETR or [PERSO]_{key}, the person could not access the user's data without knowing KEY. Only the user is able to reconstruct this data, either using the required pieces of information as KEY=K1 & K2 & K3, but through an authentication server while providing data through a registered computer (which, in one embodiment, itself supplies a data item as MAC).

For purposes of further illustrating these concepts as described above, such as where a user of an authentication device may encrypt and save the user's personal data file (here denoted “File”) directly on the device, examples will now be provided. In one embodiment, the encryption key KEY can be determined from any number of identifiers. For illustration here, it will again be assumed that three identifiers—device serial number SER, user PIN code or password PIN, and Fingerprint EMP—are required. Also assumed is that each is hashed with a common Hash function such as SHA. The Hash function can be calibrated to create numbers of any length. In one embodiment, numbers of 30 digits are used, although here, for simplicity and practicality, 3-digit numbers will be used as an example. Therefore, assuming Hash(SER)=a (for example 243); Hash(PIN)=b (for example 648); and Hash(EMP)=c (for example 532), the encryption key of the personal data file is as follows: Key=abc=[243, 648, 532]=243648532 (concatenating the three values).

A “safeguard” key SAFE can then by is transmitted via the network by the device to the server or other appropriate destination for storage. In this example, SAFE=a+b+c=1423. Again, in a more realistic application, additional security might be sought. For example, SAFE might be set to (a+b+c) modulo N, with N being defined as very large prime number, or (a XOR b XOR c), among other possibilities. In any event, this safeguard key can be saved at the server (or other location of choice), such as in the authorization table in a line corresponding to the user. Use any standard encryption algorithm (here denoted CRYPT), such as AES, DES or OTP, etc., to encrypt the personal data file File. For illustration, the encrypted file is named FiCrypt.

Thus, we have CRYPT(File, Key)=FiCrypt. This encrypted file can be saved at the user's convenience on the device or at any remote location such as on Zip storage, a network disk, a public server, etc. If the user loses one of his three (in this embodiment) identifiers (the PIN for example), it becomes impossible to decrypt the file FiCrypt. Nevertheless, the user can re-enroll using a new PIN at the authentication server or through other applicable means, as described above. Furthermore, having the authentication device, the user possesses two of the three parameters necessary to retrieve the user's encryption key.

To illustrate, in a case where a user loses or desires to change the PIN, a new PIN is received. Assuming Hash(PIN) now equals 872, the server can use the Safeguard key SAFE=1423 to determine the old “b.” Here, b=1423−(243+532)=648=(SAFE−b−c). The device can then compute the old encryption key—abc=[243, 648, 532]=243648532—and decrypting the personal data file, DECRYPT(FiCrypt,Key). The device may then compute the new encryption key, denoted Key2, and the new Safeguard key, denoted SAFE2:

| | | |
|---|---|---|
| Key2 = | a//b′//c = | 243872532 |
| SAFE2 = | a + b′ + c = | 1647 |

The device can then re-encrypt the personal data file with the new encryption key Key2 and save the encrypted file as described earlier, CRYPT(File,Key2)=FiCrypt. The device may then send the new Safeguard key (‘SAFE2’) to the server, Device→SAFE2→Server, which replaces the old Safeguard key SAFE with the new one SAFE2, such as in an authentication table with the Genonym. Such a process can be used whenever a user loses an identifier or desires a change.

In one embodiment, at the authentication device itself, with respect to authentication date there is only the serial number SER, which is stored in a secured zone inside the silicon of the microprocessor. On the network, assuming a breach, a hacker or other ill-intentioned party could have captured the safeguard keys SAFE and SAFE2. Nevertheless, as discussed below, in accordance with the invention such data might provide insufficient information to allow the hacker retrieve a, b and c, necessary to decrypt the personal data file. In this example, the hacker could only deduct the difference between b and b′ (224), which would not be of use.

At the server side, a hacker can only capture the safeguard key (SAFE2=1647). Again here, this information is not sufficient to calculate a, b and c because, as will now be described, the potential combinations the necessary data could take would be quite large. The state of the art in cryptography suggests that certain algorithms are “secure,” but that encryption keys may not be. Indeed, if an encryption algorithm is considered unbreakable, a hacker can nevertheless try all possible keys until finding the one that “works.” For this reason, it might be desirable in practicing the present invention to employ Hash functions using lengthy numbers. In one embodiment, Hash functions are used that generate 30-digits number, thereby creating an encryption key of 90 digits, creating approximately 10⁹⁰ possibilities. By comparison, 10⁸⁰ has been estimated to be the number of atoms of the universe.

It may be noted that many governments do not allow encryption with “strong” keys for files transmitted between two entities (human or computers). Often, the maximum key size authorized is between 1024 to 2048 bits. However, this may not apply in certain implementations in which an entity encrypts data for itself, which may remove legal size limit for the encryption key. In one embodiment of the present invention, that is the case, such as where a user only reads his or her personal data file, but does not transmits this file to any other entity (except potentially for safeguard purposes).

A system and method as described may derive certain effectiveness from the “dissolutive” property of the addition (modulo a big prime number) used, as well as on the difficulty to retrieve a, b and c, even knowing a+b+c. As will be demonstrated in the following example, while the algorithm may be simple the number of potential combinations achieved is quite large. In this example, the addition a+b+c is used as a simple kind of Hash dissolutive function, intentionally having a strong probability of collision.

Thus, returning to the original example, three numbers a, b and c are assumed as follows:

| | |
|---|---|
| a = | 152684269654231598762315 |
| b = | 4896532158746302501202365012 |
| c = | 3690305032545872501230147602 |

This creates an encryption key abc=1526842696542315987623154896532158746302501202 3650123690305032545872501230147602, with a+b+c=8586989875561829234031274929. In this case, there are approximately (8.5×10²⁸)²/2=36.125×10⁵⁶ possibilities of keys, all equivalent in terms of probability. In a case of a modulo of a large prime number (P), the number of possible keys is around p² keys. Offering potential perspective, if a hacker employed 1 trillion (10¹²) computers to test 1 trillion (10¹²) possible keys each second (at 60×60×24×365=31536000=3.15×10⁷ seconds per year) for 1 trillion (10¹²) years, only 3.15×10⁴³ keys would have been tried. The probability of finding the correct key under this circumstance by chance is comparable to that of winning a lottery having one-in-a-hundred-million (1/10⁸) odds, ten times in a row. For this reason, the probability of a successful exhaustive attack on such keys is considered to be quite low.

The following description outlines an alternative embodiment of the present invention in which multiple parties, such as trading partners or other associates, can confirm the identity of other parties to a transaction, etc., through the use of a TTP (again, Trusted Third Party). In one embodiment, the Genonym can only be rebuilt by the TTP if it holds previously stored data, and it associates these data to the parameters provided by each of the partners during a connection. As above in an individual case, each of the partners can simultaneously lose some of its parameters and replace them by new ones without preventing the rebuilding of the Genonym.

Generally, a case of n partners is assumed, with a hyperplane defined in an affine space of dimension m, strictly greater than n. The definition of the hyperplane in this space requires the knowledge of m independent points. The Genonym will then be a function of the coefficients of one of the equations of such a hyperplane.

By way of example, assume two partners (X and Y) and three parameters (e.g., SN, fingerprint and PIN); (x₁, x₂, x₃) for X and (y₁, y₂, y₃) for Y. The building of these parameters is such that the points of the plane of respective coordinates (x₁, y₁), (x₂, y₂), (x₃, y₃) cannot overlap. In the case where these points would be aligned (highly improbable due to the numbers sizes; approx. probability deemed to be of magnitude of 1/10⁸⁰), one partner can be asked to modify one of its parameters (e.g., the PIN) or apply a modification function stored in the identification table.

Assuming an affine space of dimension 3, each of the partners communicates its parameters to the TTP which randomly chooses three values (z₁, z₂, z₃). It thus defines three points: P1 (x₁, y₁, z₁); P2 (x₂, y₂, z₂); P3 (x₃, y₃, z₃). These three points define a plane π from which is found a Cartesian equation of z=Kx+Ly+M. In such an embodiment, the Genonym will be a function of these three coefficients K, L and M. The TTP may also compute the coordinates of one or two safety points S located on this plane, where any three of these points P1, P2, P3, S1, (S2) define the plane. After enrollment, the TTP will store the ordinates and the coordinates of the safety points in the identification table. At this time, the TTP can store hashed versions of X's and Y's parameters as entry points, while deleting the values of X's and Y's parameters and the values of K, L and M.

After receiving the parameters from X and Y, the TTP can compute the coordinates of the three points P1, P3 and P3. It then computes the equation of the plane defined by these three points, which allows it to rebuild the Genonym. It may also confirm that the safety point(s) belong to this plane, the safety points potentially providing a “back-up” in the event of lost data. In one embodiment, X and Y are authorized to each lose one parameter of the same index (e.g.: X loses x₁ and Y loses y₁ replaced by x′₁ and y′₁), even simultaneously. In a case of a loss of one parameter, during the connection, the TTP rebuilds the π plane using the points P2, P3 and safety point S. As a result, it can compute the Genonym, update the identification table replacing the ordinate z₁ by z′₁ such that P′1 (x′₁, y′₁, z′₁) belongs to the π plane. It can also modify the entries linked to x₁ and y₁ for future reference. Of course, the safety points might need readjustment if the previously referred to alignment conditions are no longer in effect. In a case of loss of a parameter by each of X and Y, one parameter of each partner is likewise replaced.

As a further example, consider a case of three partners X, Y and Z, each having three parameters. Here, a 4-dimension affine space may be used. Here, each of the partners sends its parameters to the TTP which can then build a matrix, e.g., as follows:

$$M = [ \begin{matrix}{x}_{1} , {x}_{2} , {x}_{3} \\ {y}_{1} , {y}_{2} , {y}_{3} \\ {z}_{1} , {z}_{2} , {z}_{3}\end{matrix} ]$$

The TTP may then incorporate random data to this matrix:

$${M}^{′} = [ \begin{matrix}{x}_{1} , {x}_{2} , {x}_{3} , α \\ {y}_{1} , {y}_{2} , {y}_{3} , β \\ {z}_{1} , {z}_{2} , {z}_{3} , γ \\ {u}_{1} , {u}_{2} , {u}_{3} , δ\end{matrix} ]$$

Here, the columns of the matrix contain the respective coordinates of non-coplanar points P1, P2, P3 and Γ, which define a hyperplane π of the 4-dimensional affine space, from which a Cartesian equation applies as follows:
u=ax+by+cz+d

The Genonym will thus be a function of the coefficients of this equation. Again, the TTP may also compute the coordinates of 1 or 2 safety points (S1, S2) belonging to the hyperplane. Having four points among P1, P2, P3, Γ, S1, (S2) allows the hyperplane to be rebuilt and define a subspace of dimension 3. After initial enrollment, the TTP may store the values u₁, u₂, u₃ and Γs coordinates in the identification table, using hashed versions of X's, Y's and Z's parameters as entry points. The values of X's and Y's parameters, as well as the values of K, L and M, can thereafter be purged. As in the example above, during each connection, the different partners may be authorized to have lost some parameters, so long as not to a degree to prevent the hyperplane from being rebuilt after the remaining parameters have been received.

In light of the foregoing examples, a broader mathematical explanation of the case of partner use of the present invention will be provided. Generally, in a case of n partners, an affine space of dimension n+1 is assumed, in any finite field (for example, a finite field of integers, modulo a large prime number). The definition of a hyperplane in this space is supported by knowledge of n+1 independent points. The Genonym may then be a function of the coefficients of an equation of such a hyperplane. What is desired is that a matrix M₂ (see below) be built with the coordinates of at least n+1 points of the hyperplane. A portion of the matrix may then be obscured, due to the parameters the system anticipates receiving. Only a remaining portion of the matrix need be stored in one such embodiment.

In one embodiment, a matrix M₀ is first generated as follows:

$${M}_{0} = ( \begin{matrix}{q}_{11} , & {q}_{12} & , … , & {q}_{1 p} \\ {q}_{21} , & {q}_{22} & , … , & {q}_{2 p} \\ . & . & … & . \\ . & . & … & . \\ . & . & … & . \\ . & . & … & . \\ . & . & … & . \\ {q}_{n1} , & {q}_{n2} & , … , & {q}_{np}\end{matrix} )$$

where p is the number of parameters each partner possesses, and where qᵢⱼ is subject to the following conditions: 1≦i≦n and 1≦j≦p; j being the parameter number of a partner i. Furthermore, r is assigned to represent a degree of redundancy of data. That is, the number of parameters each partner may be lacking (due to loss, etc.) during a connection. For example, if r=2 and p=3, the re-enrollment process can be achieved even if all parameters (q_{*1} to q_{*2}), (q_{*2} to q_{*3}), or (q_{*1} to q_{*3}) are lost. Of course, more strict conditions may be imposed. For instance, if n=2, one can alternatively deem each partner able to lose only one of three parameters, etc. In one embodiment, n, r and p must respect the following conditions: r<p≦n+1+r.

The TTP completes the matrix with 0, in order to build a matrix M₁ of n+1 rows and n+1+r columns. The TTP may store this matrix temporary in RAM:

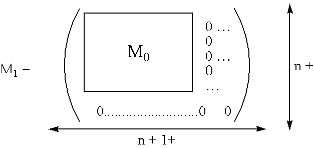

The TTP can then build a Genonym, using n+1 randomly selected numbers (a₁, a₂, . . . , aₙ₊₁). Using these numbers, a hyperplane π with the following equation can be defined:
xₙ₊₁=a₁x₁+a₂x₂ . . . +aₙxₙ+aₙ₊₁
The TTP randomly chooses (n+1+r) points in this hyperplane, verifying the condition that any (n+1) of these points are independant (i.e. enabling to rebuild the hyperplane). The TTP can then build a matrix M₂ where each of (n+1+r) columns contains the (n+1) coordinates of previously selected points:

$${M}_{2} = ( \begin{matrix}{x}_{11} , & {x}_{12} & , … , & {x}_{1 n + 1 + r} \\ {x}_{21} , & {x}_{22} & , … , & {x}_{2 n + 1 + r} \\ . & . & … & . \\ . & . & … & . \\ . & . & … & . \\ . & . & … & . \\ . & . & … & . \\ {x}_{n + 11} , & {x}_{n + 12} & , … , & {x}_{n + 1 n + 1 + r}\end{matrix} )$$

Computing M=M₁+M₂, the TTP obtains the following matrix:

$$M = ( \begin{matrix}{x}_{11} + {q}_{11} … {x}_{1 p} + {q}_{1 p} & [ {x}_{1 p + 1} … {x}_{1 n + 1 + r} ] \\ … & [ … ] \\ … & [ … ] \\ {x}_{n1} + {q}_{n1} … {x}_{np} + {q}_{np} & [ {x}_{n p + 1} … {x}_{n n + 1 + r} ] \\ [ {x}_{n + 11} … {x}_{n + 1 p} ] & [ {x}_{n + 1 p + 1} … {x}_{n + 1 n + 1 + r} ]\end{matrix} )$$

where the non-bracketed coefficients represent matrix M₂ coefficients masked by matrix M₁ and the bracketed coefficients represent matrix M₂ coefficients not masked. The TTP then stores matrix M in identification table, stores hashed versions of all partners' parameters as entry points in this table, and is able to delete all partners' parameters as well as M₀ and M₁, and the coefficients a₁, a₂, . . . , aₙ₊₁.

It may also be noted that the addition M₁+M₂ masks the first p columns of matrix M₂, Matrix M still contains the coordinates of n+1+r−p points of the hyperplane, and these points are not sufficient to rebuild the hyperplane. Indeed, with the above condition (r<p), we have n+1+r−p<n+1.

During a standard connection, each of the partners communicates its parameters to TTP which rebuilds M₀, then M₁. The TTP retrieves matrix M in the identification table then computes M₂=M−M₁. Using M₂, the TTP can now possess (n+1+r) points of the hyperplane. Since (n+1) of these points are sufficient to rebuild the hyperplane, by retrieving coefficients (a₁, a₂, . . . , aₙ₊₁), the Genonym may be computed. The remaining points should also be a part of this hyperplane.

In this embodiment, when one or more parameters has been lost or needs to be changed, each partner should communicate their remaining parameters as well as new parameters replacing the lost ones. If the above-assumed conditions for ‘r’ apply, the TTP can still rebuild at least (n+1) columns of matrix M₁, and thus of matrix M₂ as well. The TTP can determine at least (n+1) points of the hyperplane, enabling it to compute the hyperplane equation and the Genonym. The TTP then replaces incomplete columns of matrix M₂ with the coordinates of randomly chosen points of this hyperplane (following the same independence conditions described at the enrollment process). The TTP may supplements matrix M₁ with the new parameters sent by each partner in replacement of loss parameters. The TTP can compute a new matrix M=M₁+M₂ and places it in the identification table to replace the old one. The TTP may also modify the table entries linked to the new parameters. Finally, the TTP is able to releas M₀, M₁, M₂, and all partners' parameters and the coefficients a₁, a₂, . . . , aₙ₊₁.

Additional examples based on the foregoing general explanation will now be provided. In the following two examples, it is assumed that n=1 (i.e., a single user) and p=3 (3 parameters q₁, q₂, q₃). In the first example, r=1, with a 2-dimensional affine space. The user communicates its three parameters to TTP; M₀=(q₁, q₂, q₃). The TTP supplements this information to obtain:

$${M}_{1} = \begin{matrix}{q}_{1} & {q}_{2} & {q}_{3} \\ 0 & 0 & 0\end{matrix}$$

The TTP may randomly choose two coefficients (a₁, a₂), that will enable it to compute the Genonym. These coefficients determine a straight-line equation x₂=a₁x₁+a₂. The TTP randomly selects three points on this line and builds matrix M₂:

$${M}_{2} = \begin{matrix}{x}_{11} & {x}_{12} & {x}_{13} \\ {x}_{21} & {x}_{22} & {x}_{23}\end{matrix}$$

Each column of matrix M₂ contains the coordinates of one point. The TTP may then compute M₁+M₂ to obtain matrix M:

$$\begin{matrix}\begin{matrix}{x}_{11} + {q}_{1} & {x}_{12} + {q}_{2} & {x}_{13} + {q}_{3} \\ {x}_{21} & {x}_{22} & {x}_{23}\end{matrix} = \begin{matrix}{q}_{1} & {q}_{2} & {q}_{3} \\ 0 & 0 & 0\end{matrix} + \begin{matrix}{x}_{11} & {x}_{12} & {x}_{13} \\ {x}_{21} & {x}_{22} & {x}_{23}\end{matrix} \\ M = {M}_{1} + {M}_{2}\end{matrix}$$

The TTP can then store matrix M in the identification table or other appropriate storage location, the entries of the table being determined by hashed versions of parameters (q₁, q₂, q₃). In this embodiment, it may be noted that although in matrix M, the Y-coordinates of three points of the line may be known, it would nevertheless be impossible to retrieve the X-coordinates without (q₁, q₂, q₃). Consequently, the TTP cannot compute the Genonym alone.

In this embodiment, during a connection in which the user communicates its parameters to the TTP, which rebuilds matrix M₁, the TTP retrieves matrix M in identification table and computes M₂=M−M₁. The TTP now possesses the coordinates of three points. Two out of these three points enables the TTP to compute the straight line's equation. The third point should belong to this line. If the user thereafter has lost one of its parameters (assume the lost parameter is q₁, to be replaced by q′₁, the First column of matrix M₁ is incomplete. The TTP can still compute the last two columns of matrix M₂ and retrieve the coordinates of two points. The TTP can then rebuild the line's equation using these two points. The TTP can then randomly select another point of this line and puts the coordinates in first column of M₂. The TTP can then obtain a new matrix M′₂, building the new matrix of parameters M′₁ and computing M′=M′₂+M′₁. Finally, the TTP can replace M with M′ in an identification table and modify the corresponding entry point (i.e., a hashed version of q′₁).

Next, in this the second example, it is assumed that r=2, again with an affine space of 2-dimensions. Again, the user communicates its three parameters to TTP; M₀=(q₁, q₂, q₃). With this information, the TTP can obtain:

$${M}_{1} = \begin{matrix}{q}_{1} & {q}_{2} & {q}_{3} & 0 \\ 0 & 0 & 0 & 0\end{matrix}$$

If the TTP randomly chooses two coefficients (a₁, a₂), it is able to compute the Genonym. In this case, the coefficients determine a straight line equation x₂=a₁x₁+a₂. The TTP then randomly selects four points on this line and builds matrix M₂:

$${M}_{2} = \begin{matrix}{x}_{11} & {x}_{12} & {x}_{13} & {x}_{14} \\ {x}_{21} & {x}_{22} & {x}_{23} & {x}_{24}\end{matrix}$$

Each column of matrix M₂ contains the coordinates of one point. The TTP computes M₁+M₂ and obtains matrix M:

$$M = \begin{matrix}{x}_{11} + {q}_{1} & {x}_{12} + {q}_{2} & {x}_{13} + {q}_{3} & {x}_{14} \\ {x}_{21} & {x}_{22} & {x}_{23} & {x}_{24}\end{matrix}$$

The TTP stores matrix M in the identification table; the entries of the table are determined by hashed versions of parameters (q₁, q₂, q₃). In this case, however, as will be appreciated following a review of the example above, the user may lose one or two parameters and nonetheless be able to recover the situation, due to the extra redundancy point involved in this example.

Still further examples will now be provided in which it is assumed that n=2 (i.e., two partners) and p=3 (3 parameters; q₁₁, q₁₂, q₁₃ for the first partner, q₂₁, q₂₂, q₂₃ for the second partner). In the first example, it is assumed that r=1, with an affine space of two dimensions. In one such embodiment, each partner is authorized to lose one parameter at each connection, but these parameters must be of the same nature. In the first example, it is assumed that, at a point following enrollment, each partner has lost its first parameter: q₁₁ and q₂₁. Thus, at enrollment, each partner communicates its three parameters to the TTP, which builds matrix M₀:

$${M}_{0} = \begin{matrix}{q}_{11} & {q}_{12} & {q}_{13} \\ {q}_{21} & {q}_{22} & {q}_{23}\end{matrix}$$

The TTP supplements with zeros to obtain matrix M₁:

$${M}_{1} = \begin{matrix}{q}_{11} & {q}_{12} & {q}_{13} & 0 \\ {q}_{21} & {q}_{22} & {q}_{23} & 0 \\ 0 & 0 & 0 & 0\end{matrix}$$

The TTP may randomly choose three coefficients (a₁, a₂, a₃) that will enable it to compute the Genonym, where these coefficients determine a plane having the equation x₃=a₁x₁+a₂x₂+a₃. The TTP randomly selects four points on this plan, with the condition that any three of these four points not overlap, and builds matrix M₂:

$${M}_{2} = \begin{matrix}{x}_{11} & {x}_{12} & {x}_{13} & {x}_{14} \\ {x}_{21} & {x}_{22} & {x}_{23} & {x}_{24} \\ {x}_{31} & {x}_{32} & {x}_{33} & {x}_{34}\end{matrix}$$

Each column of matrix M₂ contains the coordinates of one point. The TTP computes M₁+M₂ and obtains matrix M:

$$M = \begin{matrix}{x}_{11} + {q}_{11} & {x}_{12} + {q}_{12} & {x}_{13} + {q}_{13} & {x}_{14} \\ {x}_{21} + {q}_{21} & {x}_{22} + {q}_{22} & {x}_{23} + {q}_{23} & {x}_{24} \\ {x}_{31} & {x}_{32} & {x}_{33} & {x}_{34}\end{matrix}$$

TTP stores matrix M in the identification table; the entries of the table are determined by hashed versions of parameters (q₁₁, q₁₂, q₁₃, q₂₁, q₂₂, q₂₃) It may again be noted that in matrix M, even if the coordinates of one point and the Z-coordinate of three points of the plan were known, it would be impossible to retrieve the plane equation without the partners parameters. Thus, one cannot compute the Genonym with information from the TTP alone.

When partners are ready to interact with the system, each partner may communicate its three parameters to the TTP, which can then rebuild M₁. The TTP retrieves matrix M in identification table and computes M₂=M−M₁. The TTP now possesses the coordinates of four points. Three out of those enables the TTP to compute the plane, though the fourth point should also belong to this plane. If one partner has lost one of its parameters, however, (assume the lost) parameter q₁₁), it can be replaced (here, by q′₁₁). The first column of matrix Mₗ being incomplete, the TTP can still compute the last three columns of matrix M₂, and retrieve the coordinates of three points. The TTP can then rebuilds the plane's equation using these three points. In one embodiment, the TTP then randomly selects another point of this plane and puts its coordinates in first column of M₂. This new point should also respect the conditions of non-overlap described at the enrollment process. The TTP then obtains a new matrix M′₂, builds the new matrix of parameters M′₁, then computes M′=M′₂+M′₁. The TTP replaces M with M′ in identification table and modifies the corresponding entry point (hashed version of q′₁₁). In an alternative embodiment, additional redundancy points are provided, and thus a corresponding number may be lost. In yet another embodiment, no redundant points are chosen, and thus if any data is lost, authentication would not be permitted.

As will be apparent to one skilled in the art, the inventions set forth in the above description can enable a higher degree of security and versatility than was previously available in the art. For example, authentication is granted on the basis of secured communications in which encrypted keys are unique to the authentication device used. Similarly, a process of the present invention is provided that can allow for easy password recovery provided some other authentication item availability. This compares favorably to conventional authentication means, where a lost password would typically involve manufacturing a new authentication device as well.

It should be noted that, as discussed above, disclosed methods need not include all disclosed steps or necessarily be practiced in a described order. Similarly, disclosed structures, such as various memory storage locations and characteristics (secure, read-only, etc.) are by way of example, and are not required in precise detail, but rather a subject to much potential variation, in practice of the present inventions. In addition, it is contemplated that method steps and/or system elements disclosed in one example or embodiment may be combined with one or more other steps and/or elements in one or more other examples or embodiments, to achieve a system and/or method in accordance with the invention. Further, various hashing steps and uses of encryption keys have been described as potentially improving a security of certain aspects of the inventions. However, such measures will not be required or useful in all applications. Concepts disclosed herein, while often in the context of an authentication token, may be applied to a host of other authentication devices or other concepts. For example, concepts herein might apply equally well to authentication using a device having a serial number therein, as to identity or data protection/recovery in a device, such as a credit or banking card, that may not have a serial number or other unique identifier. For these and other reasons, the inventions disclosed herein should not be limited to embodiments presented herein, but rather are defined more generally, as by the appended claims.

1. A method for authenticating a user, comprising:
receiving, at an authentication server, identification data from an authentication device;
generating random data at the authentication server;
combining the random data and the identification data to map at least two data points; and
determining a geometric curve that includes the at least two data points;
wherein an authentication decision is based on one or more characteristics of the geometric curve.

2. The method of claim 1, wherein the geometric curve is based on P data points, and wherein the authentication decision is based on the coefficients of a polynomial equation of degree D that describes the geometric curve.

3. The method of claim 1, further comprising:
storing a backup data point;
wherein when at least one item of information on which at least one of the at least two data points are based is lost, the at least one item of information can be recovered using the backup data point and a characteristic of the geometric curve.

4. The method of claim 3, wherein the at least one item of information is a user's PIN.

5. A system for user authentication on a computer system, said user operating an authentication device communicating with said computer system via at least one communication link, said authentication device comprising at least a memory means, a main processor means to process information contained in said memory means and a communication interface to send and receive information to and from said computer system through said communication link, said computer system comprising at least a memory means, a processor means to process information contained in said memory means and a communication interface to send and receive information to and from said authentication device through said communication link, characterized in that it uses the method according to any of the preceding claims.

6. A method for reaching a positive or negative determination of authentication in response to a request by an unknown user, comprising:
reaching a positive determination of authentication only when:
data received from the unknown user are combined with data stored to determine a curve, the curve having a unique mathematical property; and
the unique mathematical property matches a stored mathematical property associated with a known user;
wherein the unique mathematical property is permanently associated with the known user; and
wherein the curve having the unique mathematical property cannot be calculated from the data stored alone.

7. The method of claim 6, wherein the data received from the unknown user are combined with data stored to determine coefficients of a polynomial curve.

8. The method of claim 6, wherein the unique mathematical property represents a unique authentication number.

9. The method of claim 6, wherein the known user can retrieve previously-stored secret data only when the positive determination of authentication has been reached.
